(19) United States
(12) Patent Application Publication
(10) Pub. No.: US 2015/0217742 A1
(43) Pub. Date: Aug. 6, 2015

(54) BRAKE APPARATUS

(71) Applicant: HITACHI AUTOMOTIVE SYSTEMS, LTD., Ibaraki (JP)

(72) Inventor: Kotaro KOYAMA, Isehara-shi (JP)

(73) Assignee: HITACHI AUTOMOTIVE SYSTEMS, LTD, Ibaraki (JP)

(21) Appl. No.: 14/612,633

(22) Filed: Feb. 3, 2015

(30) Foreign Application Priority Data
Feb. 4, 2014 (JP) 2014-019152

(51) Int. Cl. B60T 13/14

(52) U.S. Cl. CPC B60T 13/14; B60T 13/142; B60T 13/147

(57) ABSTRACT

A brake apparatus includes a closed circuit including a pump configured to increase hydraulic pressures in wheel cylinders mounted on wheels with use of brake fluid drawn from a master cylinder. The brake apparatus includes a primary system hydraulic passage connecting at least one wheel cylinder of the wheel cylinders and a first chamber in the master cylinder to each other, and a secondary system hydraulic passage connecting remaining wheel cylinder of the wheel cylinders and a second chamber in the master cylinder to each other. The pump is connected so as to be able to supply the brake fluid to the primary system hydraulic passage and the secondary system hydraulic passage.

### TECHNICAL FIELD

The present invention relates to a brake apparatus mounted on a vehicle.

### BACKGROUND ART

Conventionally, there has been known a brake apparatus including a hydraulic source capable of increasing a hydraulic pressure in a wheel cylinder mounted on a wheel with use of brake fluid in a master cylinder. For example, an apparatus discussed in Japanese Patent Application Public Disclosure No. 2000-54968 includes two hydraulic passage systems, a first system and a second system, and includes two pumps, a pump for the first system and a pump for the second system as hydraulic sources.

### SUMMARY

However, the conventional apparatus includes the hydraulic source for each system, which may lead to an increase in the number of parts. An object of the present invention is to provide a brake apparatus capable of avoiding an increase in the number of parts.

To achieve the above-described object, a brake apparatus according to the present invention preferably includes a hydraulic source connected so as to be able to supply brake fluid to hydraulic passages of respective systems.

This configuration eliminates the necessity of preparing the hydraulic source for each system, thereby succeeding in avoiding the increase in the number of parts.

### BRIEF DESCRIPTION OF DRAWINGS

FIG. 1 illustrates a hydraulic passage configuration of a brake apparatus according to a first embodiment.

FIG. 2 illustrates a cross-section of a master cylinder according to the first embodiment.

FIG. 3 illustrates the state of the brake apparatus according to the first embodiment during normal brake control (when a brake pedal starts to be pressed).

FIG. 4 illustrates the state of the brake apparatus according to the first embodiment during the normal brake control (when boosting assist control is not performed).

FIG. 5 illustrates the state of the brake apparatus according to the first embodiment during the normal brake control (when the boosting assist control is performed).

FIG. 6 illustrates the state of the brake apparatus according to the first embodiment during regenerative coordination brake control (when only regenerative braking is performed).

FIG. 7 illustrates the state of the brake apparatus according to the first embodiment during the regenerative coordination brake control (when both the regenerative braking and hydraulic braking are performed).

FIG. 8 illustrates the state of the brake apparatus according to the first embodiment during ABS control (pressure reduction control) when a master cylinder pressure is high.

FIG. 9 illustrates the state of the brake apparatus according to the first embodiment during the ABS control (pressure maintenance control) when the master cylinder pressure is high.

FIG. 10 illustrates the state of the brake apparatus according to the first embodiment during the ABS control (pressure increase control) when the master cylinder pressure is high.

FIG. 11 illustrates the state of the brake apparatus according to the first embodiment during the ABS control (the pressure reduction control) when the master cylinder pressure is low.

FIG. 12 illustrates the state of the brake apparatus according to the first embodiment during the ABS control (the pressure maintenance control) when the master cylinder pressure is low.

FIG. 13 illustrates the state of the brake apparatus according to the first embodiment during the ABS control (the pressure increase control) when the master cylinder pressure is low.

FIG. 14 illustrates the state of the brake apparatus according to the first embodiment during TCS control (the pressure increase control).

FIG. 15 illustrates the state of the brake apparatus according to the first embodiment during the TCS control (the pressure maintenance control).

FIG. 16 illustrates the state of the brake apparatus according to the first embodiment during the TCS control (the pressure reduction control).

FIG. 17 illustrates the state of the brake apparatus according to the first embodiment during VDC control (the pressure increase control) for controlling two wheels to same pressures.

FIG. 18 illustrates the state of the brake apparatus according to the first embodiment during the VDC control (the pressure maintenance control) for controlling two wheels to same pressures.

FIG. 19 illustrates the state of the brake apparatus according to the first embodiment during the VDC control (the pressure reduction control) for controlling two wheels to same pressures.

FIG. 20 illustrates the state of the brake apparatus according to the first embodiment during the VDC control (the pressure increase control) for controlling two wheels to different pressures.

FIG. 21 illustrates the state of the brake apparatus according to the first embodiment during the VDC control (the pressure maintenance control) for controlling two wheels to different pressures.

FIG. 22 illustrates the state of the brake apparatus according to the first embodiment during the VDC control (the pressure reduction control) for controlling two wheels to different pressures.

FIG. 23 illustrates the state of the brake apparatus according to the first embodiment during failed system identification control.

FIG. 24 illustrates a hydraulic passage configuration of a brake apparatus according to a second embodiment.

FIG. 25 illustrates a hydraulic passage configuration of a brake apparatus according to a third embodiment.

FIG. 26 illustrates a hydraulic passage configuration of a brake apparatus according to a fourth embodiment.

### DESCRIPTION OF EMBODIMENTS

In the following description, embodiments for carrying out a brake apparatus according to the present invention will be described with reference to the drawings.

### First Embodiment

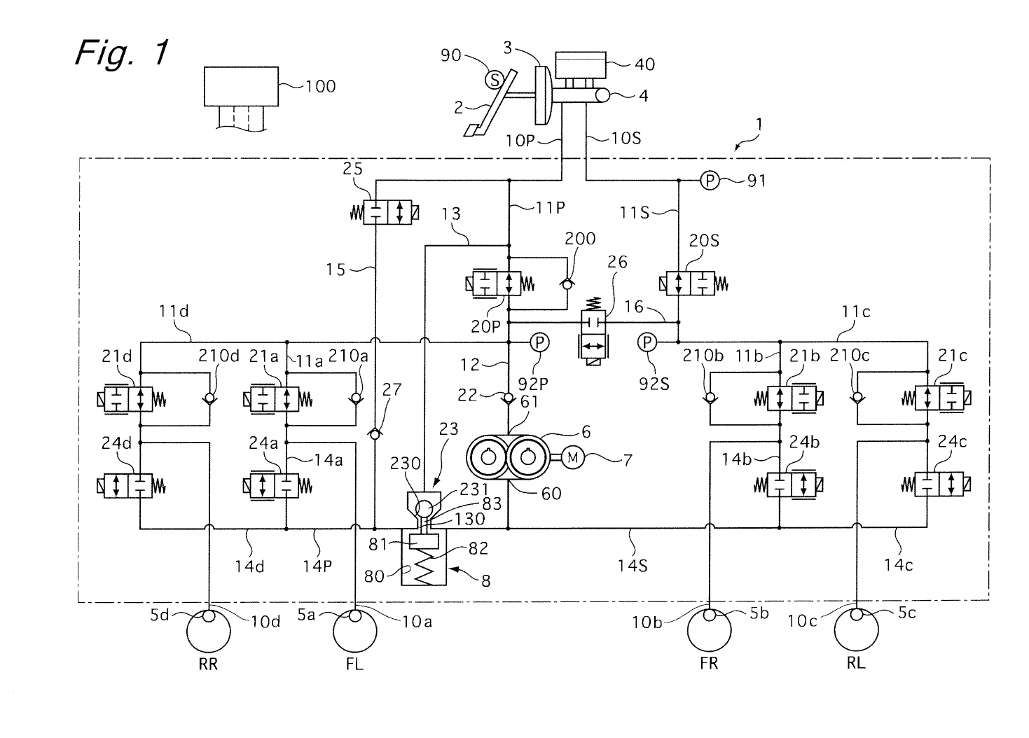

First, a configuration of a brake apparatus 1 (hereinafter simply referred to as an apparatus 1) according to the first embodiment will be described. FIG. 1 illustrates a hydraulic passage configuration of the apparatus 1. The apparatus 1 is applied to a hydraulic brake system of an electric vehicle. The electric vehicle is a hybrid vehicle including a motor/generator (a rotating electrical machine) in addition to an engine (an internal-combustion engine) as a prime mover for driving wheels. Such an electric vehicle can carry out regenerative braking for braking the vehicle by converting motion energy of the vehicle into electric energy with use of a regenerative brake apparatus including the motor/generator. The apparatus 1 may be mounted on a vehicle including only the motor/generator or only the engine (for example, a diesel engine) as a source for driving the wheels. Further, the vehicle on which the apparatus 1 is mounted is a small-sized front-drive passenger vehicle. However, the apparatus 1 can be mounted on not only the small-sized vehicle but also a middle-sized vehicle and a large-sized vehicle. Further, the drive method of the vehicle is not limited to the front-drive method.

The hydraulic brake system includes the apparatus 1, a brake pedal 2, a booster 3, a master cylinder 4, wheel cylinders 5, and a brake controller 100. The brake pedal 2 is a braking operation member that receives an input of a braking operation from an operator (a driver). A stroke sensor 90, which detects a displacement amount of the brake pedal 2 (a pedal stroke as an amount of the braking operation performed by the driver), is disposed on the brake pedal 2. The booster 3 is a brake booster that transmits a force of the braking operation (a force pressing the brake pedal 2) to the master cylinder 4 while boosting it. More specifically, the booster 3 is a negative pressure type booster (a negative pressure booster) that utilizes a negative pressure generated by the engine as a power source. The booster 3 is configured to work based on a low negative pressure, and a boosting ratio realized by the booster 3 is smaller than commonly-used negative pressure boosters. The present embodiment improves the performance regarding fuel efficiency by configuring the booster 3 to work based on a low negative pressure in the small-sized vehicle. The booster 3 does not necessarily have to be configured to work based on a low negative pressure.

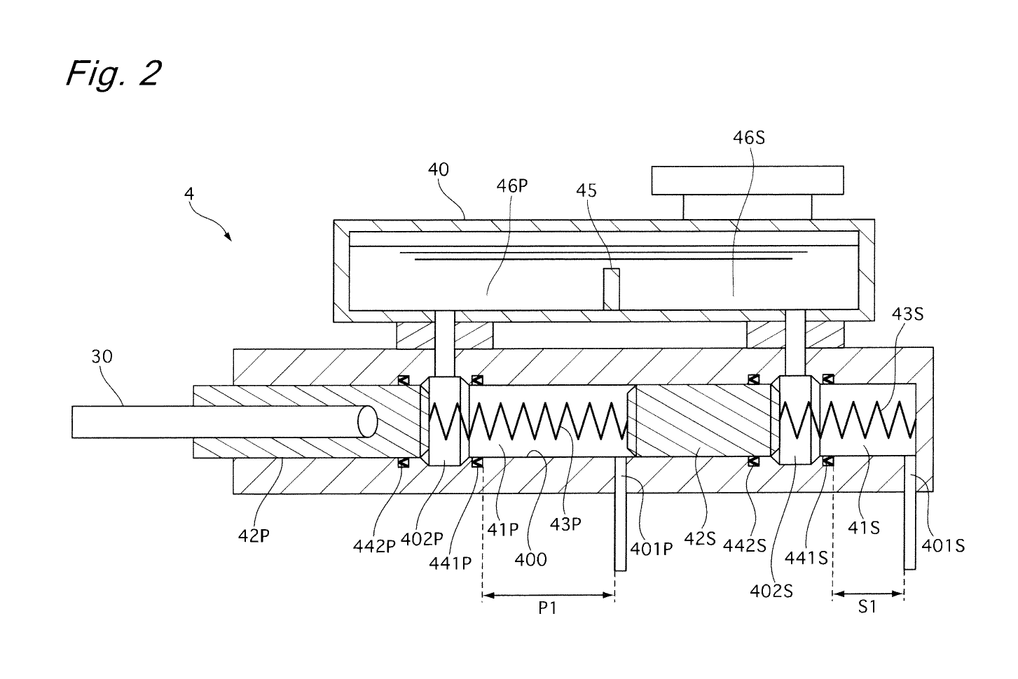

The master cylinder 4 is actuated by a force applied from the booster 3 via a push rod 30 (refer to FIG. 2), and generates a hydraulic pressure in proportion to this force, i.e., a hydraulic pressure (a master cylinder pressure) according to a state of the braking operation. A reservoir tank 40 is integrally provided to the master cylinder 4 as a fluid source that stores hydraulic fluid (brake fluid). The master cylinder 4 receives a refill of the brake fluid from the reservoir tank 40. The master cylinder 4 is a so-called tandem type master cylinder, and includes a primary piston 42P connected to the push rod 30, and a secondary piston 42S configured as a free piston as master cylinder pistons axially movable according to the braking operation. The master cylinder 4 is connected to the wheel cylinders 5 respectively mounted on wheels FL, FR, RL, and RR of the vehicle via brake pipes 10P and 10S of two systems independent of each other (a primary P system and a secondary S system). The wheel cylinders 5 each generate a hydraulic pressure (a wheel cylinder pressure) by receiving a supply of the brake fluid, thereby applying a hydraulic braking force (a frictional braking force with use of a frictional force generated by the hydraulic pressure) to each of the wheels FL to RR.

Hereinafter, when a component provided in correspondence to the P system and a component provided in correspondence to the S system should be distinguished from each other, indices P and S will be added at the ends of the respective reference numerals. Components provided in correspondence to the respective vehicle wheels FL, FR, RL, and RR will be distinguished from one another with use of alphabets, a, b, c, and d added as necessary, in which a, b, c, and d correspond to the front left wheel FL, the front right wheel FR, the rear left wheel FL, and the rear right wheel RR, respectively. The brake pipes 10P and 10S are configured as a so-called X type dual circuit having a diagonal structure. The pipe 10P in the P system extending from the master cylinder 4 is divided into brake pipes 10a and 10d, which are connected to the wheel cylinders 5a and 5d on the front left wheel FL and the rear right wheel RR, respectively. The pipe 10S in the S system extending from the master cylinder 4 is divided into brake pipes 10b and 10c, which are connected to the wheel cylinders 5b and 5c on the front rear wheel FR and rear left wheel RL, respectively. The brake pipes may be configured as a so-called a front-rear structure, i.e., an H type pipe structure that is divided into two systems of the front wheels FL and FR and the rear wheels RL and RR.

FIG. 2 is a partial cross-sectional view schematically illustrating a cross-section of the master cylinder 4 taken along a plane extending through an axis of the master cylinder 4. The pistons 42 of the master cylinder 4 are inserted in a bottomed cylindrical cylinder 400 axially movably along an inner circumferential surface of the cylinder 400. The cylinder 400 includes discharge ports (supply ports) 401 and refill port 402s for the respective P and S systems. The refill ports 402 are connected to the reservoir tank 40 and are in communication therewith. A partition member 45 is disposed in the reservoir tank 40, and a space 46P on the P system side and a space 46S on the S system side are defined by the partition member 45. The refill port 402P of the master cylinder 4 is connected to the space 46P, and the refill port 402S is connected to the space 46S. A primary chamber 41P as a first chamber (a hydraulic chamber) is defined between the pistons 42P and 42S in the cylinder 400. A secondary chamber 41S as a second chamber (a hydraulic chamber) is defined between the piston 42S and an axial end of the cylinder 400. Coil springs 43P and 43S as return springs are disposed in both the chambers 41P and 41S respectively. The discharge ports 401 are constantly opened to the chambers 41P and 41S. The discharge ports 401 are provided so as to be connected to the apparatus 1 and be communicable with the wheel cylinders 5.

Piston seals 44 are provided on the inner circumference of the cylinder 400. The piston seals 44 are a plurality of seal members in slidable contact with the respective pistons 42P and 42S to seal between outer circumferential surfaces of the respective pistons 42P and 42S and the inner circumferential surface of the cylinder 400. Each of the piston seals 44 is a known seal member (a cup seal) having a cup-like shape in cross-section that includes a lip portion on a radially inner side. When the lip portion is in slidable contact with the outer circumferential surface of the piston 42, the piston seal 44 permits the brake fluid to flow in one direction while prohibiting the brake fluid from flowing in an opposite direction. A first piston seal 441 is oriented so as to permit the brake fluid to flow from the refill port 402 to the discharge port 401 while prohibiting the brake fluid from flowing in a reverse direction thereof. A second piston seal 442P of the P system is oriented so as to prohibit the brake fluid from flowing out of the cylinder 400 via the refill port 402P. A second piston seal 442S of the S system is oriented so as to prohibit the brake fluid from flowing from the refill port 402S to the primary chamber 41P.

The both chambers 41P and 41S are reduced in volume, and hydraulic pressures (master cylinder pressures) are generated therein, when the pistons 42 perform strokes according to a driver's operation of pressing the brake pedal 2. As a result, the brake fluid is supplied from the both chambers 41P and 41S toward the wheel cylinders 5 via the discharge ports 401. Approximately equal hydraulic pressures are generated in the both chambers 41P and 41S for the P system and the S system. The master cylinder 4 can increase pressures in the wheel cylinders 5a and 5d by the master cylinder pressure generated in the primary chamber 41P via the pipe 10P (a supply hydraulic passage 11P) in the P system, and can also increase pressures in the wheel cylinders 5b and 5C by the master cylinder pressure generated in the secondary pressure 41S via the pipe 10S (a supply hydraulic passage 11S) in the S system.

The chambers 41P and 41S are formed in such a manner that the volume of the primary chamber 41P is larger than the volume of the secondary chamber 41S. The both chambers 41P and 41S have approximately equal radial dimensions, but the chambers 41P and 41S are formed in such a manner that an axial dimension of the primary chamber 41P is larger than an axial dimension of the secondary chamber 41S. More specifically, the chambers 41P and 41S are formed in such a manner that a distance P1 from the first piston seal 441P of the primary chamber 41P to the discharger port 401P is longer than a distance S1 from the first piston seal 441S of the secondary chamber 41S to the discharger port 401S. The distance P1 is set in such a manner that the primary chamber 41P can have a volume that allows the primary chamber 41P to supply a brake fluid amount required for all of the four wheel cylinders 5a to 5d. The distance S1 is set in such a manner that the secondary chamber 41S can have a volume that allows the secondary chamber 41S to supply a brake fluid amount required for the two wheel cylinders 5b and 5c.

The apparatus 1 is a brake hydraulic controller provided so as to be able to control the brake hydraulic pressures at the respective wheels FL, FR, RL, and RR of the vehicle independently of the driver's braking operation. The apparatus 1 is a hydraulic unit connected to the master cylinder 4 via the brake pipes 10P and 10S, and also connected to the wheel cylinders 5 via the brake pipes 10a to 10d. A housing of the apparatus 1 contains hydraulic passages 11 and the like that are passages inside which the brake fluid moves (flows). The hydraulic passages 11 and the like are provided in correspondence to the P and S systems. The apparatus 1 includes a pump 6 that is a hydraulic generation source, and a plurality of control valves (electromagnetic valves 20 and the like), as hydraulic devices (actuators) for generating control hydraulic pressures to be supplied to the respective wheel cylinders 5. The electromagnetic valves 20 and the like are opened and closed according to control signals to switch communication states of the hydraulic passages 11 and the like, thereby controlling a flow of the brake fluid. The apparatus 1 includes hydraulic sensors 91 and 92 that detect a discharge pressure of the pump 6, the master cylinder pressure, and the like. When the brake pedal 2 is pressed, the master cylinder 4 supplies the brake fluid (the master cylinder pressures) to the apparatus 1 via the brake pipes 10P and 10S. The apparatus 1 is provided so as to be able to individually supply the master cylinder pressures or the control hydraulic pressures to the respective wheel cylinders 5 via the brake pipes 10a to 10d. The apparatus 1 is provided so as to be able to control the hydraulic pressures in the respective wheel cylinders 5 (the wheel cylinder pressures) to lower values than the master cylinder pressures, also able to control the hydraulic pressures in the respective wheel cylinders 5 (the wheel cylinder pressures) to values equal to or higher than the master cylinder pressures, and further able to maintain the hydraulic pressures in the respective wheel cylinders 5 (the wheel cylinder pressures) approximately constant, by being controlled by the brake controller 100.

Detection values transmitted from the pedal stroke sensor 90 and the hydraulic sensors 91 and 92, and information (wheel speeds, a steering angle, a battery SOC, and the like) regarding a running state transmitted from the vehicle side (another controller and the like) via a communication line are input into the brake controller 100. The brake controller 100 performs information processing according to a program installed therein based on these various kinds of information. Further, the brake controller 100 outputs control instructions to the respective actuators in the apparatus 1 to control them according to a result of this processing. More specifically, the brake controller 100 controls opening/closing operations of the electromagnetic values 20 and the like, and the number of rotations of a motor 7 that drives the pump 6 (i.e., an amount discharged from the pump 6). By this control, the brake controller 100 controls the wheel cylinder pressures at the respective wheels FL to RR, thereby realizing boosting assist control for generating hydraulic braking forces that would otherwise be insufficient only from the driver's braking operation (boosted by the booster 3) to thereby assist the braking operation (an operation of the booster 3), regenerative coordination brake control for controlling the wheel cylinder pressures so as to achieve a target deceleration (target braking forces) in cooperation with the regenerative braking, anti-lock brake control (hereinafter referred to as ABS control) for preventing the wheels FL to RR from slipping (being prone to be locked) caused by being braked, brake control for controlling a movement of the vehicle (vehicle stability assist control such as electronic stability control) (hereinafter referred to as VDC control), brake control for a traction control system for preventing driving wheels from slipping when the vehicle stars to run or is accelerated (hereinafter referred to as TCS control), and the like. For example, during the ABS control, the brake controller 100 extracts the speeds of the respective wheels FL to RR as vehicle information, and detects and monitors slip states of the wheels FL to RR. Upon detecting that some wheel is prone to be locked, i.e., determining that a slip amount of this wheel (a deviation amount of the speed of this wheel from a speed of a simulated vehicle body) is excessive while generating braking forces on the wheels FL to RR according to the driver's braking operation (during normal brake control), the brake controller 100 interferes with the normal brake control, and controls the hydraulic pressure of the wheel cylinder 5 in this wheel so as to increase or reduce it. In this manner, the brake controller 100 controls the slip amount of this wheel in such a manner that this amount matches an appropriate predetermined value.

The brake controller 100 calculates target wheel cylinder pressures based on the pedal stroke from the stroke sensor 90 and information from another sensor. For example, the brake controller 100 calculates driver request braking forces (a vehicle deceleration G requested from the driver) based on the detected pedal stroke. In the present embodiment, the driver request braking forces are defined to mean hydraulic braking forces corresponding to the wheel cylinder pressures that will be generated according to the pedal stroke by an operation of the negative pressure booster when the braking operation is performed, assuming that the hydraulic brake system includes a negative pressure booster that is not configured to work based on a low negative pressure and configured to realize a normal boosting ratio. During the normal brake control, the brake controller 100 sets the wheel cylinder pressures corresponding to the above-described driver request braking forces as the target hydraulic pressures in the wheel cylinders 5 (the target wheel cylinder pressures). By this setting, the brake controller 100 can set the target wheel cylinder pressures that realize a predetermined boosting ratio assuming that the negative pressure booster is not configured to work on a low negative pressure, i.e., an ideal relation characteristic between the pedal stroke and the driver request braking forces (requested brake hydraulic pressures). During the regenerative coordination brake control, for example, when the above-described driver request braking forces cannot be satisfied only by regenerative braking forces (a value input from another controller), the brake controller 100 sets the wheel cylinder pressures corresponding to hydraulic braking forces for supplementing this insufficiency as the target wheel cylinder pressures. During the ABS control, the brake controller 100 calculates the target wheel cylinder pressures of the respective wheels FL to RR so as to achieve appropriate slip amounts of the respective wheels FL to RR. During the VDC control, the brake controller 100 calculates the target wheel cylinder pressures of the respective wheels FL to RR so as to achieve a desired vehicle movement condition based on, for example, a detected vehicle movement state amount (a lateral acceleration and the like). During the TCS control, the brake controller 100 calculates the target wheel cylinder pressures of the respective driving wheels FL and RR so as to achieve appropriate slip amounts of the respective driving wheels FL and FR.

Next, a hydraulic passage configuration of the apparatus 1 will be described with reference to FIG. 1. The hydraulic passages of the apparatus 1 form a so-called closed circuit that can increase the hydraulic pressures in the respective wheel cylinders 5 with use of the brake fluid in the hydraulic chamber 41 of the master cylinder 4, and returns the brake fluid used for the increases to the hydraulic chamber 41 in the master cylinder 4. First, the P system will be described. The hydraulic passage in the P system of the apparatus 1 includes the supply hydraulic passage 11P connected to the brake pipe 10P, thereby connecting the primary chamber 41P in the master cylinder 4 and the wheel cylinders 5 to each other. A shutoff valve (a cutoff valve) 20P, which switches communication and discommunication of the supply hydraulic passage 11P, is disposed in the supply hydraulic passage 11P. A check valve 200, which permits the brake fluid to only flow from the master cylinder 4 side to the wheel cylinder 5 side, is disposed in a bypass hydraulic passage provided in parallel with the shutoff valve 20P. The check valve 200 is opened so as to transmit the master cylinder pressure to the discharge side of the pump 6 and a pressure increase valve 21 side when the master cylinder pressure exceeds the pressure on the wheel cylinder 5 side or a pressure on the discharge side of the pump 6. The supply hydraulic passage 11P is divided into supply hydraulic passages 11a and 11d on the wheel cylinder 5 side with respect to the shutoff valve 20P. The supply hydraulic passage 11a is connected to the wheel cylinder 5a on the front left wheel FL, and the supply hydraulic passage 11d is connected to the wheel cylinder 5d on the rear right wheel RR. Pressure increase valves 21a and 21d, which switch communication and discommunication of the supply hydraulic passages 11a and 11d, are disposed in the supply hydraulic passages 11a and 11d, respectively. Check valves 210, which permit the brake fluid to only flow from the wheel cylinder 5 side to the master cylinder 4 side, are disposed in bypass hydraulic passages provided in parallel with the pressure increase valves 21. The check valves 210 are opened so as to release the wheel cylinder pressures to the master cylinder 4 side when the wheel cylinder pressures fall below the pressure on the master cylinder 4 side or the pressure on the discharge side of the pump 6.

The pump 6 is connected to the supply hydraulic passage 11P via a discharge hydraulic passage 12. In other words, the pump 6 is connected so as to be able to supply the brake fluid to the supply hydraulic passage 11P via the discharge hydraulic passage 12. The discharge hydraulic passage 12 connects a portion in the supply hydraulic passage 11P that is located between the shutoff valve 20P and the pressure increase valves 21a and 21d, and a discharge portion 61 of the pump 6. A check valve 22 as a discharge valve of the pump 6 is disposed in the discharge hydraulic passage 12. The check valve 22 permits the brake fluid to only flow from the discharge portion 61 of the pump 6 to the supply hydraulic passage 11P. The hydraulic sensor 92P is disposed in the supply hydraulic passage 11P between the shutoff valve 20P and the pressure increase valves 21a and 21d. The hydraulic sensor 92P detects a hydraulic pressure at this portion, i.e., the pressure on the discharge side of the pump 6 (the discharge pressure of the pump 6), and inputs the detected value to the brake controller 100. Further, the pump 6 is connected to the supply hydraulic passage 11P via a first intake hydraulic passage 13. The first intake hydraulic passage 13 connects a portion in the supply hydraulic passage 11P that is located between the primary chamber 41P of the master cylinder 4 and the shutoff valve 20P, and an intake portion 60 of the pump 6.

The pump 6 is a hydraulic source that can increase the hydraulic pressures in the wheel cylinders 5 with use of the brake fluid in the master cylinder 4 (the primary chamber 41P), and is rotationally driven by the motor 7 to draw and discharge the brake fluid. In the present embodiment, a rotational gear pump excellent in an anti-noise and anti-vibration performance and the like, in particular, an external gear pump is employed as the pump 6. The type of the pump 6 is not limited to the external gear type, and may be an internal gear type such as a trochoid pump. Further, the pump 6 is not limited to a rotational pump, and may be a reciprocating pump such as a plunger pump. The number of rotations of the motor 7 is controlled according to an instruction voltage from the brake controller 100. The motor 7 is a direct-current brushless motor, but is not limited thereto. The pump 6 is included in the P system (the hydraulic passage therein), which is the same system as the supply hydraulic passage 11P, and receives a supply of the brake fluid not from the secondary chamber 41S of the master cylinder 4 but from the primary chamber 41P of the master cylinder 4 (the pump 6 draws the brake fluid from the primary chamber 41P). In other words, the discharge hydraulic passage 12 and the first intake hydraulic passage 13 are not (directly) connected to the supply hydraulic passage 11S in the S system but are (directly) connected to the supply hydraulic passage 11P in the P system, thereby constituting a part of the P system (the hydraulic passage therein). The pump 6 is connected to these hydraulic passages 12 and 13, and therefore is included in the P system (the hydraulic passage therein). Further, the pump 6 can be also considered to be included in the supply hydraulic passage 11P with such an interpretation that the first intake hydraulic passage 13 provided in parallel with the supply hydraulic passage 11P and the discharge hydraulic passage 12 constitute a part of the supply hydraulic passage 11P as bypass hydraulic passages of the supply hydraulic passage 11P.

An internal reservoir 8 is disposed in the first intake hydraulic passage 13. The internal reservoir 8 is a reservoir tank contained in the apparatus 1 and disposed so as to be able to store a predetermined amount of the brake fluid. The internal reservoir 8 is a reservoir provided with a pressure adjustment function that is provided so as to be able to adjust the hydraulic pressures in the hydraulic passages (pressure adjustment). The internal reservoir 8 includes a check valve 23 as a pressure adjustment valve that adjusts an amount of the brake fluid flowing into the internal reservoir 8. The check valve 23 is located between a connection point of the first intake hydraulic passage 13 to the supply hydraulic passage 11P, and the internal reservoir 8.

The internal reservoir 8 includes a cylinder 80, a piston 81, a spring 82, and a rod 83. A portion of the first intake hydraulic passage 13 that is connected to the supply hydraulic passage 11P, and a portion of the first intake hydraulic passage 13 that is connected to the pump 6 are opened at one axial end of the cylinder 80. An opposite axial end of the cylinder 80 forms a closed bottom portion. The piston 81 is disposed so as to be reciprocatable in the cylinder 80. The spring 82 is mounted while being pressed and compressed between the opposite axial end (the bottom portion) of the cylinder 80 and the piston 81, and constantly biases the piston 81 toward the one axial end side of the cylinder 80. A space on the one axial end side of the cylinder 80 that is defined by the piston 81 serves as a volume chamber that can store the brake fluid, and a space on the opposite axial end side of the cylinder 80 that is defined by the piston 81 serves as a backpressure chamber opened to a approximately atmospheric pressure. The volume chamber and the backpressure chamber are liquid-tightly defined by a seal member mounted on an outer circumference of the piston 81.

The check valve 23 includes a valve seat 230 and a valve body 231. The valve seat 230 is formed on a hydraulic passage 130 extending approximately in parallel with an axis of the cylinder 80 at a position in the first intake hydraulic passage 13 on the supply hydraulic passage 11P side with respect to the internal reservoir 8. The valve body 231 has a ball-like shape, and blocks the communication of the hydraulic passage 130 by being seated on the valve seat 230, while establishing the communication of the hydraulic passage 130 by being separated from the valve seat 230. The rod 83 in the internal reservoir 8 is disposed so as to penetrate through inside the hydraulic passage 130. A one end of the rod 83 is disposed so as to be able to abut against a surface of one axial end side of the piston 81, and an opposite end of the rod 83 is disposed so as to be able to abut against the valve body 231. When the piston 81 is displaced toward the one axial end side of the cylinder 80 (in a direction for reducing a volume of the volume chamber) by a predetermined amount or more, the rod 83 lifts up the valve body 231 from the valve seat 230, thereby establishing the communication of the hydraulic passage 130. On the other hand, when the piston 81 is displaced toward the opposite axial end side of the cylinder 80 (in a direction for increasing the volume of the volume chamber) by a predetermined amount or more, the rod 83 is contained in the hydraulic passage 130 and the valve body 231 is seated on the valve seat 230 (for example, by a biasing force of a not-illustrated check valve return spring), thereby blocking the communication of the hydraulic passage 130.

The supply hydraulic passages 11a and 11d are connected to the first intake hydraulic passage 13 via pressure reduction hydraulic passages 14a and 14d, respectively. More specifically, the pressure reduction hydraulic passages 14a and 14d branch off from between the pressure increase valves 21a and 21d in the supply hydraulic passages 11a and 11d and the wheel cylinders 5a and 5d, respectively. Pressure reduction valves 24a and 24d, which switch communication and discommunication of the pressure reduction hydraulic passages 14a and 14d, are disposed in the pressure reduction hydraulic passages 14a and 14d, respectively. The pressure reduction hydraulic passages 14a and 14d are merged with each other to form a pressure reduction hydraulic passage 14P. This pressure reduction hydraulic passage 14P is connected to the internal reservoir 8, and is opened to the one axial end of the cylinder 80 (within the volume chamber). Further, a portion in the supply hydraulic passage 11P that is located between the primary chamber 41P in the master cylinder 4 and the shutoff valve 20P is connected to the internal reservoir 8 via a second intake hydraulic passage 15. The second intake hydraulic passage 15 connects a portion between a connection point of the supply hydraulic passage 11P to the first intake hydraulic passage 13 and the primary chamber 41P in the master cylinder 4, to the internal reservoir 8. The second intake hydraulic passage 15 is opened to the one axial end of the cylinder 80 (within the volume chamber) together with the pressure reduction hydraulic passage 14P. An intake valve 25, which switches communication and discommunication of the second intake hydraulic passage 15, is disposed in the second intake hydraulic passage 15. A check valve 27, which permits the brake fluid to only flow from the intake valve 25 side toward the internal reservoir 8 side, is disposed in the second intake hydraulic passage 15 between the intake valve 25 and the internal reservoir 8.

Next, the S system will be described. The hydraulic passage in the S system includes the supply hydraulic passage 11S connected to the brake pipe 10S, thereby connecting the secondary chamber 41S in the master cylinder 4 and the wheel cylinders 5 to each other. A shutoff valve (a cutoff valve) 20S, which switches communication and discommunication of the supply hydraulic passage 11S, is disposed in the supply hydraulic passage 11S. No check valve is disposed in parallel with the shutoff valve 20S, unlike the P system. The hydraulic sensor 91 is disposed in the supply hydraulic passage 11S between the secondary chamber 41S in the master cylinder 4 and the shutoff valve 20S. The hydraulic sensor 91 detects a hydraulic pressure at this portion, i.e., the master cylinder pressure, and inputs the detected value into the brake controller 100. The hydraulic sensor 92S is disposed in the supply hydraulic passage 11S between the shutoff valve 20S and pressure increase valves 21b and 21c. The hydraulic sensor 92S detects a hydraulic pressure at this portion, and inputs the detected value into the brake controller 100. Among hydraulic passages branching off from the supply hydraulic passage 11S, the supply hydraulic passage 11b is connected to the wheel cylinder 5b on the front right wheel FR, and the supply hydraulic passage 11C is connected to the wheel cylinder 5c on the rear left wheel RL. The pressure increase valves 21b and 21c, which switch communication and discommunication of the supply hydraulic passages 11b and 11c, are disposed in the supply hydraulic passages 11b and 11c, respectively. Check valves 210 are disposed in parallel with the pressure increase valves 21 in a similar manner to the P system. The supply hydraulic passages 11b and 11c are connected to the first intake hydraulic passage 13 via pressure reduction hydraulic passages 14b and 14c, respectively. Pressure reduction valves 24b and 24c, which switch communication and discommunication of the pressure reduction hydraulic passages 14b and 14c, are disposed in the pressure reduction hydraulic passages 14b and 14c, respectively. The pressure reduction hydraulic passages 14b and 14c are merged with each other to form a pressure reduction hydraulic passage 14S. The pressure reduction hydraulic passage 14S is connected to a portion in the first intake hydraulic passage 13 that is located between the internal reservoir 8 and the pump 6 (the intake portion 60), and is connected to the internal reservoir 8 and the pump 6 via the first intake hydraulic passage 13.

The supply hydraulic passage 11P in the P system and the supply hydraulic passage 11S in the S system are connected to each other via a connection hydraulic passage 16. One end of the connection hydraulic passage 16 is connected to a portion in the supply hydraulic passage 11P that is located between the shutoff valve 20P and the pressure increase valves 21a and 21d. An opposite end of the connection hydraulic passage 16 is connected to a portion in the supply hydraulic passage 11S that is located between the shutoff valve 20S and the pressure increase valves 21b and 21c. In other words, the shutoff valve 20S is disposed between a connection point of the supply hydraulic passage 11S to the connection hydraulic passage 16, and the secondary chamber 41S in the master cylinder 4. A communication valve (a switching valve) 26, which switches communication and discommunication of the connection hydraulic passage 16, is disposed in the connection hydraulic passage 16. No pump is disposed in the S system (the hydraulic passage therein). The discharge portion 61 of the pump 6 is connected to the supply hydraulic passage 11S via the discharge hydraulic passage 12, the supply hydraulic passage 11P, and the connection hydraulic passage 16. In other words, the pump 6 is connected so as to be able to supply the brake fluid to the supply hydraulic passage 11S via the communication hydraulic passage 16 and the like. Further, the internal reservoir 8, the first and second intake hydraulic passages 13 and 15, and the intake valve 25 are not disposed in the S system.

Each of the valves 20, 21, and 24 to 26 are a well-known electromagnetic valve (a solenoid valve) that generates an electromagnetic force in response to a supply of a driving current to a solenoid (a coil) to reciprocate a valve body (plunger), thereby being opened and closed. Each of the shutoff valves 20 and the pressure increase valves 21 is a normally-opened valve that is opened when power is not supplied. Each of the pressure reduction valves 24, the intake valve 25, the communication valve 26 each are a non tally-closed valve that is closed when power is not supplied. Each of the shutoff valve 20P in the P system, the respective pressure increase valves 21, and the pressure reduction valves 24a and 24b in one of the systems is a proportional control valve that adjusts an opening degree of the valve according to the current supplied to the solenoid. An effective current is controlled by PWM (pulse width modulation). Each of the other valves, i.e., the shutoff valve 20S in the S system, the intake valve 25, and the pressure reduction valves 24d and 24c in the other of the systems is an ON/OFF valve that is switched to be opened and closed in a binary manner. The proportional control valve may be used as the above-described other valves. For example, regarding the shutoff valve 20P, the hydraulic passage 11P is closed by abutment of the valve body against the valve seat, and is opened by a separation of the valve body from the valve seat. The spring as the return spring biases the valve body away from the valve seat. The solenoid generates the electromagnetic force for moving the valve body toward the valve seat side against the biasing force of the spring when power is supplied to the solenoid. The valve body is moved against the biasing force (a spring force) of the spring with the aid of this electromagnetic force. The area of the flow passage between the valve seat and the valve body (the opening degree of the valve) is changed according to a movement (stroke) amount of the valve body, which controls a fluid amount passing though the shutoff valve 20P and hydraulic pressures in the hydraulic passage in front of and at the back of the shutoff valve 20P (a pressure difference therebetween). Instead of the proportional control valve, for example, the ON/OFF valve may be used as the shutoff valve 20P and the like, but it is preferable to use the proportional control valve to reduce a noise and a vibration to improve the driver's feeling.

The internal reservoir 8 stores the brake fluid transmitted from the wheel cylinder 5 side via the pressure reduction valves 24 (the pressure reduction hydraulic passages 14), or transmitted from the master cylinder 4 side via the intake valve 25 and the like (the second intake hydraulic passage 15). The pump 6 extracts the brake fluid stored in the internal reservoir 8 by drawing this brake fluid, and discharges the brake fluid to the discharge hydraulic passage 12 to supply the brake fluid to the supply hydraulic passage 11P. Further, the pump 6 draws the brake fluid from the master cylinder 4 side via the check valve 23 and the internal reservoir 8 (the first intake hydraulic passage 13), and discharges the brake fluid to the discharge hydraulic passage 12 to thereby supply the brake fluid to the supply hydraulic passage 11P. The brake fluid supplied to the supply hydraulic passage 11P is supplied to the wheel cylinders 5 via the pressure increase valves 21 to thereby be used for increases in the wheel cylinder pressures, or is returned to the master cylinder 4 side (the primary chamber 41P) via the shutoff valve 20P. The supply hydraulic passage 11P forms a hydraulic passage to which the brake fluid is supplied from the master cylinder 4 (the primary chamber 41P), and also forms a return hydraulic passage that returns the supplied brake fluid to the master cylinder 4 (the primary chamber 41P).

The check valve 23 operates in cooperation with the piston 81 in the internal reservoir 8 to adjust an amount of the brake fluid introduced from the first intake hydraulic passage 13 into the internal reservoir 8. When a pressure is applied from the master cylinder 4 side with the pump 6 stopped, the check valve 23 blocks the communication of the first intake hydraulic passage 13 to prohibit the brake fluid from flowing from the master cylinder 4 side toward the intake side of the pump 6 via the internal reservoir 8. On the other hand, when the pump 6 is in operation, the check valve 23 establishes the communication of the first intake hydraulic passage 13 to preferentially enable a flow of the brake fluid from the master cylinder 4 side toward the intake side of the pump 6 via the internal reservoir 8. In the following description, this operation will be described specifically. When the pump 6 is out of operation and the brake fluid is not supplied from the master cylinder 4, the piston 81 in the internal reservoir 8 is biased by the spring 82 to push up the valve body 231 of the check valve 23 via the rod 83 (for example, against the force of the not-illustrated check valve return spring). Therefore, the valve body 231 is separated from the valve seat 230 by a predetermined amount, whereby the check valve 23 is opened. At this time, the first intake hydraulic passage 13 is in communication with the intake side of the pump 6 via the internal reservoir 8. When the brake fluid is introduced (stored) into the internal reservoir 8 by a predetermined amount, the check valve 23 is closed, thereby blocking the flow of the brake fluid from the master cylinder 4 side toward intake side of the pump 6 via the first intake hydraulic passage 13.

When the master cylinder pressure Pm is supplied from the first intake hydraulic passage 13, the check valve 23 shifts from the opened state to the closed state. Assume that F represents the biasing force of the spring 82 (a force resulting from a subtraction of the biasing force of the above-described check valve return spring), and S1 represents a pressure-receiving area of the piston 81. When the master cylinder pressure Pm is applied to the piston 81 with the check valve 23 opened, and Pm×S1 exceeds F (Pm×S1>F), the piston 81 moves (performs a stroke) in a direction for compressing the spring 82, whereby the valve body 231 also moves (performs a stroke) toward the valve seat 230. When the valve body 231 performs the stroke by the above-described predetermined amount to be seated on the vale seat 230, the brake fluid is prohibited from flowing from the first intake hydraulic passage 13 into the internal reservoir 8. When the brake fluid in the wheel cylinders 5 is introduced into the internal reservoir 8 via the pressure reduction passages 14, or the brake fluid in the master cylinder 4 is introduced into the internal reservoir 8 via the second intake hydraulic passage 15, the piston 81 moves in the direction for compressing the spring 82 to increase the volume of the internal reservoir 8 to allow the brake fluid to be stored therein. The piston 81 and the valve body 231 are separate members, and are formed in such a manner that a stroke amount of the piston 81 (an upper limit thereof) is larger than a stroke amount of the valve body 231 (an upper limit thereof). Therefore, even after the valve body 231 is seated on the valve seat 230 by performing the stroke by the above-described predetermined amount, the piston 81 can perform a stroke to increase the amount of the brake fluid stored in the internal reservoir 8.

When the check valve 23 is closed, a pressure on the valve body 231 on the master cylinder 4 side is equal to the master cylinder pressure Pm. On the other hand, a pressure Ps on the valve body 231 on the internal reservoir 8 side is F/S1 at most. Therefore, the pressure Ps applied to the intake side of the pump 6 does not reach or exceed F/S1, and is maintained at a predetermined pressure or lower. When the pump 6 is in operation, the brake fluid stored in the internal reservoir 8 is drawn up, and is supplied to the supply passage 11P side. At this time, even when the check valve 23 is closed, the pressure in the internal reservoir 8 is reduced according to the pumping by the pump 6, so that the check valve 23 is pushed to be opened. In other words, when the pump 6 draws up the brake fluid from the internal reservoir 8 with the check valve 23 closed, the pressure Ps is reduced, so that the piston 81 is pushed toward the valve body 231 side with the aid of the biasing force F of the spring 82. At this time, assuming that S2 represents a diameter of the hydraulic passage of the check valve 23 (a diameter of the valve seat), i.e., a cross-sectional area of the passage when the brake fluid flows through the check valve 23, satisfaction of Pm×S2<F causes the valve body 231 to be separated from the valve seat 230, thereby opening the check valve 23. A valve opening pressure F/S2 is set to a predetermined pressure. When the check valve 23 is opened in this manner, the pump 6 is placed in such a state that the pump 6 can draw the brake fluid from the internal reservoir 8 and also draw the brake fluid from the master cylinder 4 (the first intake hydraulic passage 13). Then, when the master cylinder pressure Pm is applied to the piston 81 in the internal reservoir 8 to move the piston 81 in the direction for compressing the spring 82, the check valve 23 is opened as described above. In this manner, when the pump 6 is in operation, the check valve 23 is automatically repeatedly opened and closed, thereby allowing the pump 6 to draw the brake fluid from the master cylinder 4 (the first intake hydraulic passage 13) to increase the wheel cylinder pressure Pw, and also adjust the pressure applied to the intake side of the pump 6 to the predetermined value or lower.

### <Operation>

Next, an operation of the apparatus 1 will be described. First, overviews of operation states of the actuators (the electromagnetic valves 20, and the motor 7 or the pump 6) and a flow of the brake fluid in each state of the apparatus 1 will be described. FIG. 1 illustrates the apparatus 1 in a non-braking state when the driver does not perform the braking operation. The apparatus 1 is out of operation. No power is supplied to the respective actuators. The shutoff valves 20 and the pressure increase valves 21 are actuated in the valve opening directions, while the pressure reduction valves 24, the intake valve 25, and the communication valve 26 are actuated in the valve closing directions.

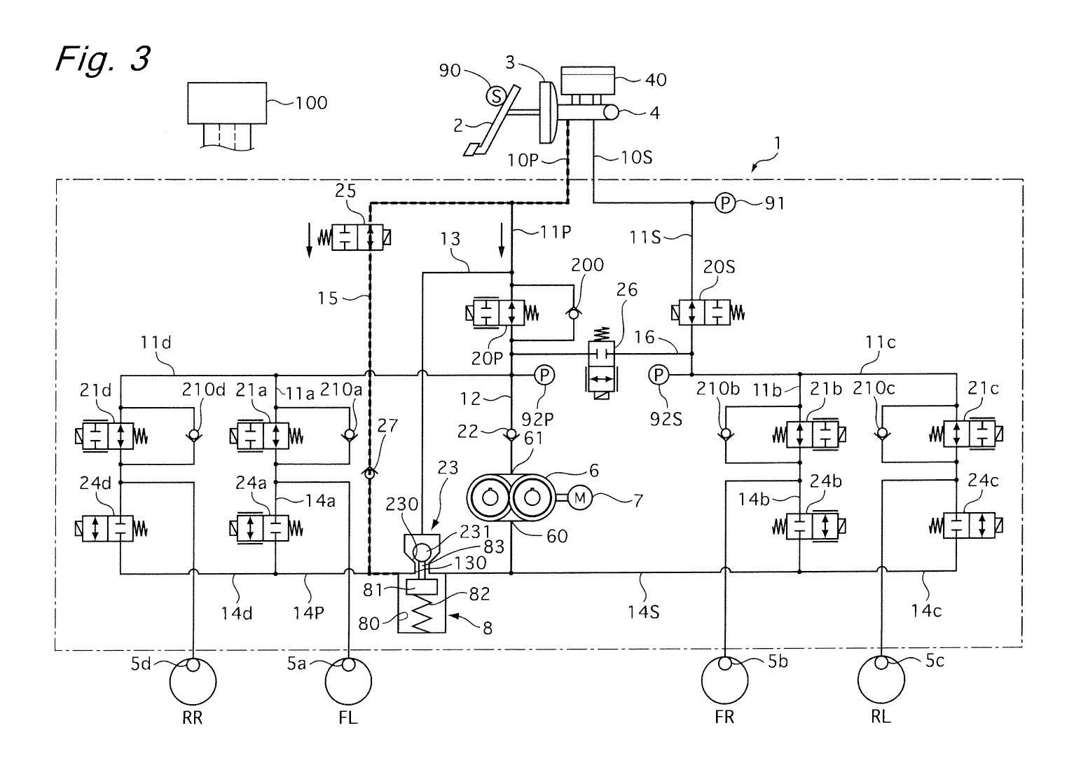

FIGS. 3 to 23 illustrate the hydraulic passage configuration of the apparatus 1 in a similar manner to FIG. 1. Each of arrows indicates a direction in which the brake fluid flows. Each of dotted lines indicates a low pressure, and each of alternate long and short dash lines indicates a higher pressure than the dotted lines.

### (Normal Brake Control)

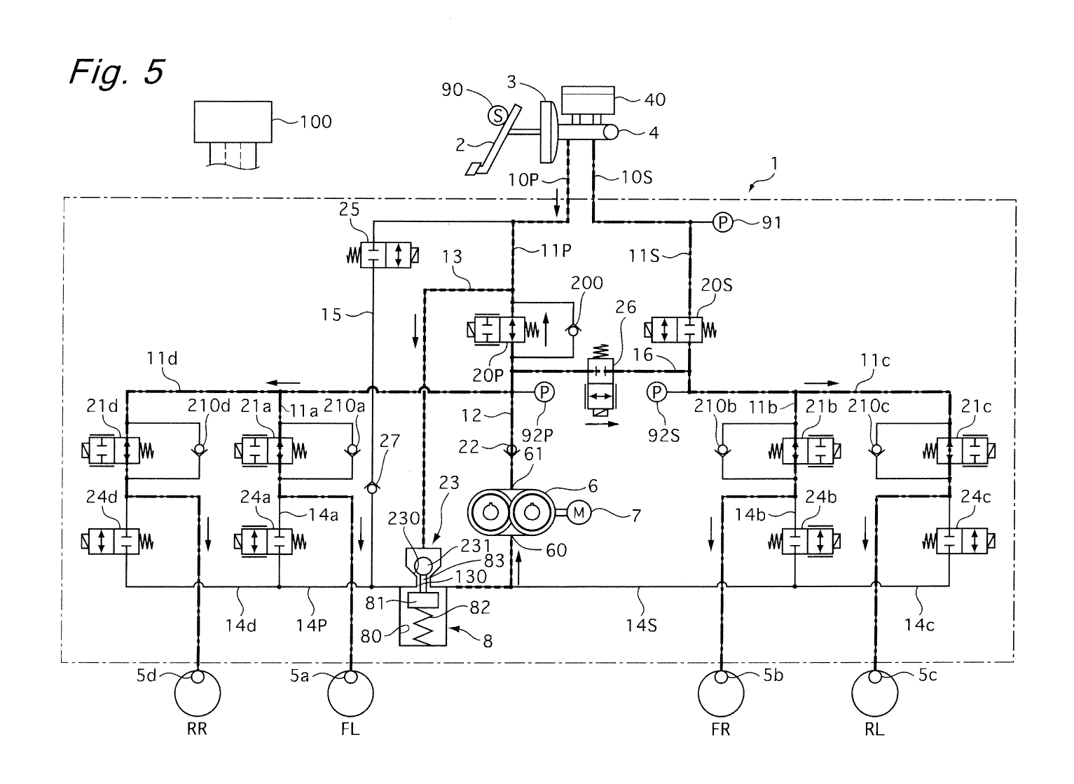

FIGS. 3 to 5 illustrate the state of the apparatus 1 during the normal brake control that generates the wheel cylinder pressures (the hydraulic braking forces) on the front and rear wheels FR to RR according to the driver's braking operation (the pedal stroke). FIG. 3 illustrates the state of the apparatus 1 when the brake pedal 2 starts to be pressed. The brake controller 100 determines that the brake pedal 2 starts to be pressed when, for example, the detected pedal stroke is larger than zero and smaller than a predetermined value. Power is supplied to the intake valve 25, which causes the intake valve 25 to be actuated in the valve opening direction, while power is not supplied to the other actuators. The primary piston 42P in the master cylinder 4 performs a slight stroke. The brake fluid delivered from the primary chamber 41P toward the apparatus 1 is supplied to the wheel cylinder 5a and 5d in the P system by slight amounts after being transmitted through the supply hydraulic passage 11P via the shutoff valve 20P. Further, the brake fluid delivered from the primary chamber 41P to the supply hydraulic passage 11P is introduced into the internal reservoir 8 after being transmitted through the second intake hydraulic passage 15 via the intake valve 25 and the check valve 23. A predetermined amount of the brake fluid is stored in the internal reservoir 8. The secondary piston 42S in the master cylinder 4 performs a slight stroke. The brake fluid delivered from the secondary chamber 41S toward the apparatus 1 is supplied to the wheel cylinder 5b and 5c in the S system by slight amounts after being transmitted through the supply hydraulic passage 11S via the shutoff valve 20S. In this manner, the apparatus 1 prepares for pumping up in a high pressure region that will be described below (FIG. 5) by the stroke of the brake pedal 2 and the storage of the brake fluid into the internal reservoir 8.

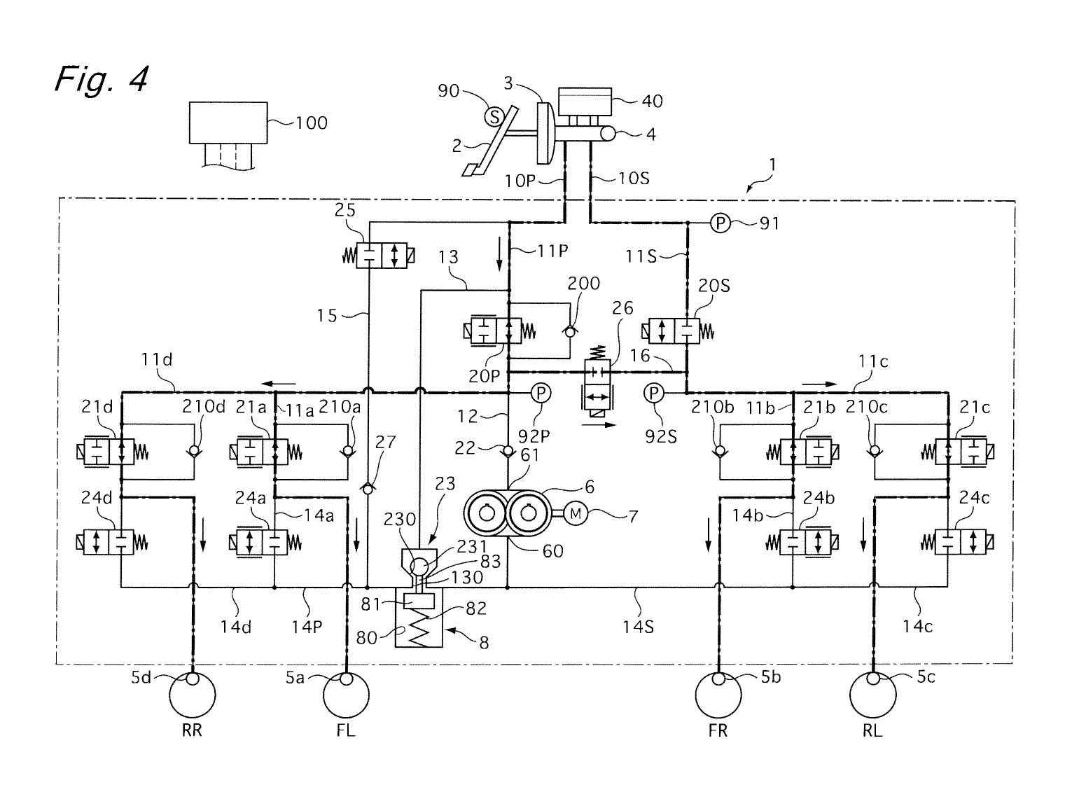

FIG. 4 illustrates the state of the apparatus 1 when the boosting assist control is not performed because the target wheel cylinder pressures are within a low pressure region in which the target wheel cylinder pressures can be achieved only by the pressing force on the brake pedal 2 (the boosting ratio of the booster 3). The brake controller 100 determines that the target wheel cylinder pressures are within the above-described low pressure region when, for example, the calculated target wheel cylinder pressures are lower than a predetermined value after determining that the brake pedal 2 starts to be pressed. The apparatus 1 increases the pressures in the wheel cylinders 5 by the master cylinder pressures generated by the pressing force (the operation of the booster 3) to realize the target wheel cylinder pressures. More specifically, power is supplied to the shutoff valve 20S in the S system to actuate the shutoff valve 20S in the valve closing direction. The communication valve 26 is subjected to the PWM control, so that its valve opened state is controlled. Power is not supplied to the other actuators. The primary piston 42P in the master cylinder 4 performs a slight stroke. The brake fluid delivered from the primary chamber 41P toward the apparatus 1 is supplied to the wheel cylinders 5a and 5d after being transmitted through the supply hydraulic passage 11P via the shutoff valve 20P and the pressure increase valves 21a and 21d. Further, the brake fluid delivered from the primary chamber 41P toward the apparatus 1 is supplied to the wheel cylinders 5b and 5c after being transmitted through the supply hydraulic passage 11P, the connection hydraulic passage 16, and the supply hydraulic passage 11S via the shutoff valve 20P, the communication valve 26, and the pressure increase valves 21b and 21c. Since the intake valve 25 is actuated in the valve closing direction, the brake fluid delivered from the primary chamber 41P toward the apparatus 1 is not introduced into the internal reservoir 8 via the second intake hydraulic passage 15. The above-described predetermined amount of the brake fluid remains stored in the internal reservoir 8. The secondary piston 42S in the master cylinder 4 does not perform a stroke. The brake fluid delivered from the secondary chamber 41S toward the supply hydraulic passage 11S is blocked by the shutoff valve 20S actuated in the valve closing direction, and therefore is not supplied to the wheel cylinders 5a to 5d. In this manner, the hydraulic pressures are generated in the respective wheel cylinders 5 by the brake fluid (the master cylinder pressure) supplied from the primary chamber 41P (pressing force braking).

FIG. 5 illustrates the state of the apparatus 1 when the boosting assist control is performed because the target wheel cylinder pressures are in the high pressure region where these pressures cannot be achieved by the pressing force on the brake pedal 2 alone. The brake controller 100 determines that the target wheel cylinder pressures are in the high pressure region when, for example, the calculated target wheel cylinder pressures are the predetermined value or higher after determining that the brake pedal 2 starts to be pressed. The apparatus 1 increases (pumps up) the pressures in the wheel cylinders 5 with use of a pressure discharged from the pump 6, thereby achieving the target wheel cylinder pressures. More specifically, the shutoff valve 20P in the P system is subjected to the PWM control, so that its valve opened state is controlled. Power is supplied to the shutoff valve 20S in the S system to actuate the shutoff valve 20S in the valve closing direction. The communication valve 26 is subjected to the PWM control, so that its valve opened state is controlled. The motor 7 is subjected to the PWM control, so that the amount discharged from the pump 6 is controlled. Power is not supplied to the other actuators. The pump 6 draws the brake fluid stored in the internal reservoir 8 (when the brake pedal 2 starts to be pressed), and discharges the brake fluid to the supply hydraulic passage 11P via the discharge hydraulic passage 12. The discharged brake fluid is supplied to the wheel cylinders 5a and 5d after being transmitted through the supply hydraulic passage 11P via the pressure increase valves 21a and 21d. Further, the discharged brake fluid is supplied to the wheel cylinders 5b and 5c after being transmitted through the supply hydraulic passage 11P, the connection hydraulic passage 16, and the supply hydraulic passage 11S via the communication valve 26 and the pressure increase valves 21b and 21c. The valve opened state of the shutoff valve 20P is controlled so that an amount of the brake fluid returned to the primary chamber 41P side via the shutoff valve 20P is adjusted, by which the pressure in the supply hydraulic passage 11P on the pump 6 side with respect to the shutoff valve 20P (i.e., the hydraulic pressures in the wheel cylinders 5a and 5d), and the pressure in the supply hydraulic passage 11S on the pressure increase valve 21 side with respect to the shutoff valve 20S (i.e., the hydraulic pressures in the wheel cylinders 5b and 5c) are controlled.

More specifically, the valve body of the shutoff valve 20P receives a force based on a differential pressure between the pressure on the primary chamber 41P side (corresponding to the master cylinder pressure) and the pressure on the pump 6 side (corresponding to the wheel cylinder pressure), in addition to the biasing force of the spring and the electromagnetic force according to a value of the current supplied to the solenoid. The biasing force of the spring is fixedly determined according to the position of the valve body. When a certain current value is set, the valve body performs a stroke to adjust the valve opened state of the shutoff valve 20P, thereby automatically adjusting an amount of the brake fluid (a leak fluid amount) transmitted through the shutoff valve 20P, until a balance is established between the electromagnetic force according to this current value, the biasing force of the spring, and the force from the above-described differential pressure. Therefore, the above-described differential pressure (i.e., the wheel cylinder pressure) can be controlled to a desired value by control of the current value. In this manner, hydraulic pressures are generated in the respective wheel cylinders 5 with the aid of the brake fluid supplied from the pump 6, and unnecessary fluid is leaked from the shutoff valve 20P in the P system, by which the hydraulic pressures in the respective wheel cylinders 5 are controlled.

At least when the pump 6 starts to operate, the pump 6 does not draw the brake fluid from the primary chamber 41P via the first intake hydraulic passage 13, but draws the brake fluid stored in the internal reservoir 8 (when the brake pedal 2 starts to be pressed). Further, the pump 6 is continuously rotated, by which the pressures in the wheel cylinders 5 can be increased with excellent responsiveness. The brake fluid leaked from the shutoff valve 20P in the P system is returned into the internal reservoir 8 via the first intake hydraulic passage 13, and is drawn by the pump 6 again. In this manner, the hydraulic passage configuration forms a circulation hydraulic passage through which the brake fluid is circulated, thereby succeeding in eliminating or reducing an influence of the operation of the pump 6 on the master cylinder pressure while maintaining the wheel cylinder pressures at the target hydraulic pressures even when the pump 6 is continuously rotated.

### (Regenerative Coordination Brake Control)

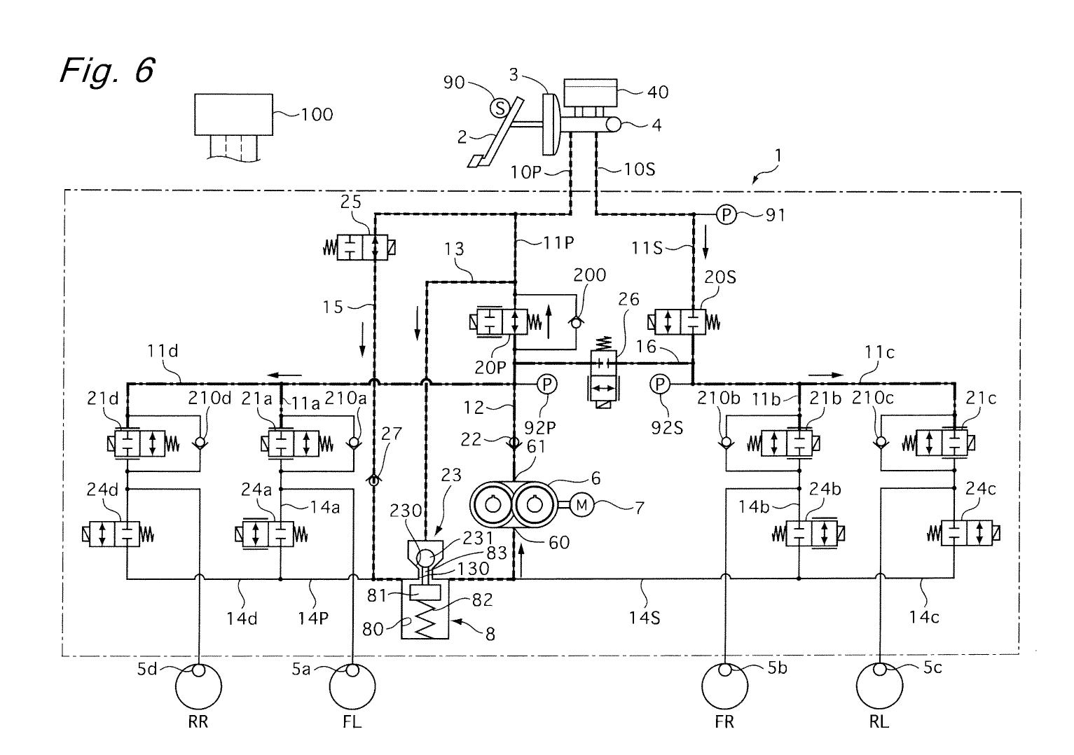

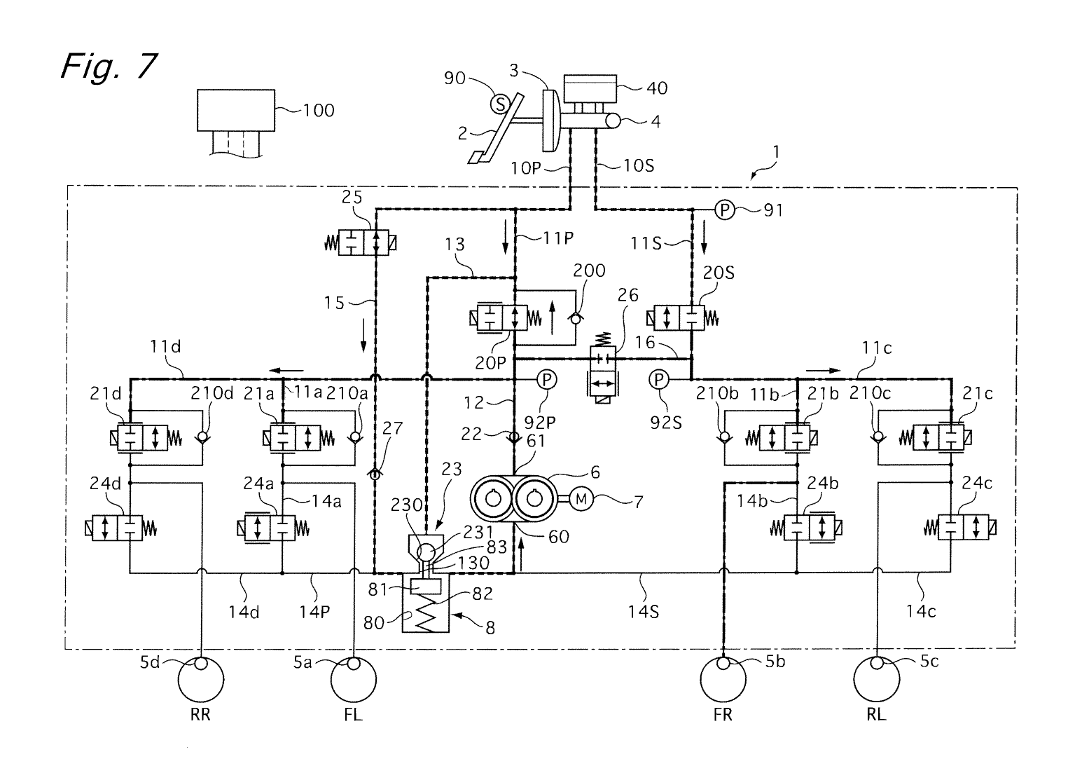

FIGS. 6 and 7 illustrate the state of the apparatus 1 when the regenerative coordination brake control is performed while the driver performs the braking operation. FIG. 6 illustrates the state of the apparatus 1 when only the regenerative braking is performed. The shutoff valve 20P in the P system is subjected to the PWM control, so that its valve opened state is controlled. Power is supplied to the shutoff valve 20S in the S system to activate the shutoff valve 20S in the valve closing direction. Power is supplied to the intake valve 25 to actuate the intake valve 25 in the valve opening direction. The communication valve 26 is subjected to the PWM control, so that its valve opened state is controlled. The motor 7 is subjected to the PWM control, so that the amount discharged from the pump 6 is controlled. Power is supplied to the respective pressure increase valves 21 to actuate the pressure increase valves 21 in the valve closing directions. Power is not supplied to the respective pressure reduction valves 24. The primary piston 42P in the master cylinder 4 performs a stroke. The brake fluid delivered from the primary chamber 41P toward the apparatus 1 is introduced into the internal reservoir 8 after being transmitted through the second intake hydraulic passage 15 via the intake valve 25 and the check valve 23. As a result, an amount of the brake fluid corresponding to the regenerative braking force is stored into the internal reservoir 8 according to the stroke of the brake pedal 2. The secondary piston 42S in the master cylinder 4 does not perform a stroke. The brake fluid delivered from the secondary chamber 41S to the supply hydraulic passage 11S is blocked by the shutoff valve 20S actuated in the valve closing direction. Once a predetermined amount of the brake fluid is stored in the internal reservoir 8, the intake valve 25 may be actuated in the valve closing direction after that.

The pump 6 is continuously rotated, by which the pressures in the wheel cylinders 5 can be increased with excellent responsiveness at the end of the regenerative braking. More specifically, the regenerative braking force cannot be generated when the vehicle speed is a predetermined value or lower, whereby the braking force should be switched to the hydraulic braking force. Therefore, actuating the pump 6 in advance even during the regenerating braking can prevent a delay in a response of the pump 6 when the braking force is switched as described above. The pump 6 draws the brake fluid from the internal reservoir 8 and discharges the brake fluid into the supply hydraulic passage 11P via the discharge hydraulic passage 12. Since the respective pressure increase valves 21 are actuated in the valve closing directions, the brake fluid is prohibited from being supplied from the supply hydraulic passage 11P to the respective wheel cylinders 5. The valve opened state of the shutoff valve 20P is controlled, by which the brake fluid in the supply hydraulic passage 11P on the pump 6 side with respect to the shutoff valve 20P is leaked into the supply hydraulic passage 11P on the primary chamber 41P side with respect to the shutoff valve 20P. The leaked brake fluid is returned into the internal reservoir 8 via the first intake hydraulic passage 13, and is drawn by the pump 6 again. In this manner, the hydraulic passage configuration forms the circulation hydraulic passage, thereby succeeding in eliminating or reducing the influence of the operation of the pump 6 on the master cylinder pressure while maintaining the wheel cylinder pressures at approximately zero pressures. The valve opened state of the shutoff valve 20P is controlled, so that the brake fluid is transmitted toward the primary chamber 41P side via the shutoff valve 20P by an adjusted amount (the brake fluid is transmitted through the shutoff valve 20P by an adjusted amount), by which the master cylinder pressure or the pedal stroke is controlled. In addition thereto, the master cylinder pressure or the pedal stroke may be controlled by control of the valve opened state of the intake valve 25 to discharge the brake fluid toward the internal reservoir 8 side via the intake valve 25 by an adjusted amount.

FIG. 7 illustrates the state of the apparatus 1 when both the regenerative braking and the hydraulic braking (frictional braking with use of the hydraulic pressures) are performed, for example, when the braking mode is switched from the regenerative braking to the hydraulic braking. The respective pressure increase valves 21 are subjected to the PWM control, so that their valve opened states are controlled. The other actuators operate in a similar manner to the control using the regenerative braking alone (FIG. 6). The valve opened states of the respective pressure increase valves 21 are adjusted, by which the hydraulic pressures in the respective wheel cylinders 5 are controlled. The other operations are similar to FIG. 6. More specifically, the brake fluid is leaked from the supply hydraulic passages 11 to the respective wheel cylinders 5 via the respective pressure increase valves 21, thereby increasing the pressures in the respective wheel cylinders 5. The regenerative braking forces are reduced according to the increases in the hydraulic braking forces in this manner. During this period, the pump 6 is continuously driven, thereby leaking an unnecessary amount of the brake fluid to the supply hydraulic passage 11P on the primary chamber 41P side to cause the brake fluid to circulate through the above-described circulation hydraulic passage. The wheel cylinder pressures are estimated, for example, in the following manner. The pressure increase valves 21 are controlled in such a manner that these estimated values match the target wheel cylinder pressures. More specifically, assume that, at the time of a start of the regenerative braking, the wheel cylinder pressures are approximately zero when the pressure increase valves 21 are actuated in the valve closing directions. The braking mode starts to be switched from the regenerative braking to the hydraulic braking, and the wheel cylinder pressures after the pressure increase valves 21 are actuated in the valve opening directions can be calculated based on amounts of the brake fluid transmitted from the supply hydraulic passages 11 on the pump 6 side with respect to the shutoff valves 20 to the wheel cylinder 5 side via the pressure increase valves 21. These fluid amounts are proportional to products of differential pressures between upstream sides of the pressure increase valves 21 (the supply hydraulic passages 11 on the shutoff valve 20 side or the pump 6 side with respect to the pressure increase valves 21) and downstream sides of the pressure increase valves 21 (the supply hydraulic passages 11 on the wheel cylinder 5 side with respect to the pressure increase valves 21), and time periods during which the pressure increase valves 21 are opened. Therefore, the wheel cylinder pressures after the pressure increase valves 21 are actuated in the valve opening directions can be estimated from the time periods during which the pressure increase valves 21 are opened. In the above description, the estimation has been described assuming that the wheel cylinder pressures when the regenerative braking (alone) is performed by actuating the pressure increase valves 21 in the valve closing directions are approximately zero. However, predetermined wheel cylinder pressures (corresponding to, for example, the master cylinder pressure generated immediately before the pressure increase valves 21 are actuated in the valve closing directions) may be generated.

### (ABS Control)

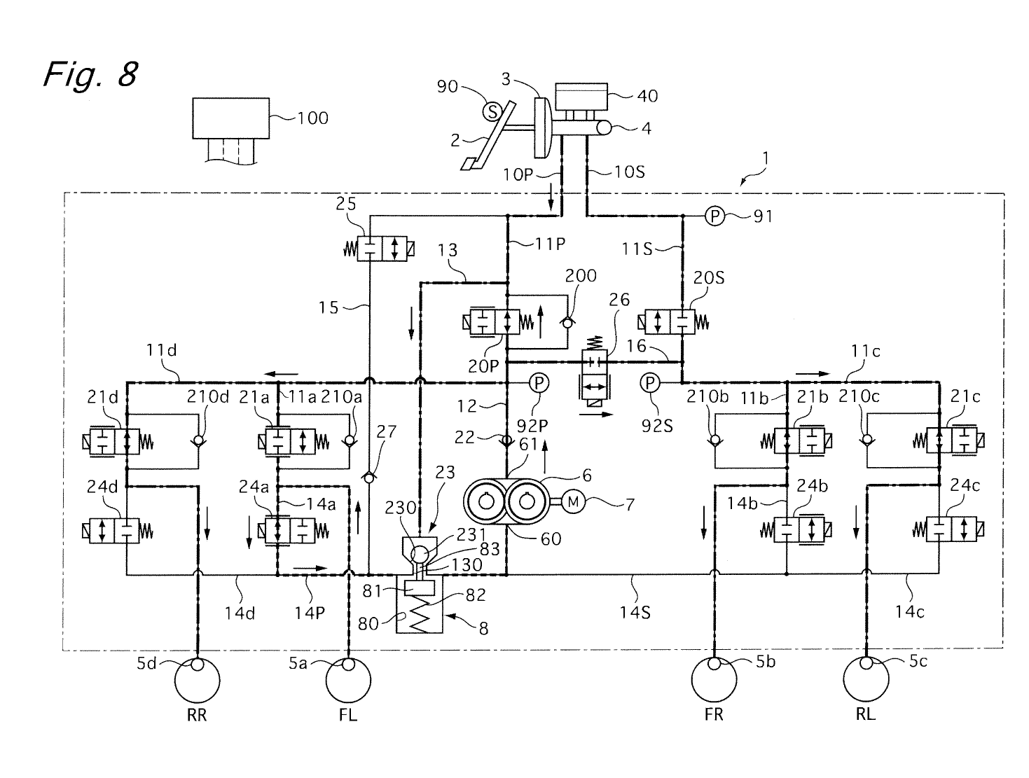

FIGS. 8 to 10 illustrate the state of the apparatus 1 during the ABS control when the master cylinder pressure is high. When the master cylinder pressure is high, the braking force (the wheel cylinder pressure) can be sufficiently generated only by the pressing force on the brake pedal 2 (the master cylinder pressure), so that the braking force does not have to be generated with use of the pump 6, and the master cylinder pressure is not lower than the wheel cylinder pressure, in a similar manner to FIG. 4. Examples of a situation when the ABS control is exercised at such a time include the vehicle being running on a road surface having a small frictional coefficient (a low μ road). Hereinafter, this control will be referred to as ABS control 1. The hydraulic pressure in the wheel cylinder 5 on a control target wheel is controlled by adjustments of the valve opened states of the pressure increase valve 21 and the pressure reduction valve 24 corresponding to this wheel cylinder 5. The master cylinder pressure is supplied to the wheel cylinders 5 that are not the control target wheel.

FIG. 8 illustrates the state of the apparatus 1 when the wheel cylinder pressure in the control target wheel FL is controlled so as to be reduced. Power is supplied to the shutoff valve 20S in the S system to actuate the valve 20S in the valve closing direction. The communication valve 26 is subjected to the PWM control, so that its valve opened state is controlled. The motor 7 is subjected to the PWM control, so that the amount discharged from the pump 6 is controlled. Power is supplied to the pressure increase valve 21a corresponding to the wheel cylinder 5a on the control target wheel FL to actuate the valve 21a in the valve closing direction. Power is supplied to the pressure reduction valve 24a corresponding to the wheel cylinder 5a to actuate the valve 24a in the valve opening direction. Power is not supplied to the other actuators. The brake fluid delivered from the wheel cylinder 5a toward the apparatus 1 is introduced into the internal reservoir 8 after being transmitted through the pressure reduction hydraulic passage 14a via the pressure reduction valve 24a. As a result, the pressure in the wheel cylinder 5a is reduced. The wheel cylinder pressure is estimated, for example, in the following manner. The pressure reduction valve 24 is controlled in such a manner that this estimated value matches the target wheel cylinder pressure. At the time of a start of the ABS control (the pressure reduction control), the wheel cylinder pressure when the pressure increase valve 21 is actuated in the valve closing direction is approximately equal to the master cylinder pressure, and is a value detected by the hydraulic sensor 91 or 92. The wheel cylinder pressure after the pressure increase valve 21 is actuated in the valve closing direction can be calculated based on the wheel cylinder pressure when the pressure increase valve 21 is actuated in the valve closing direction, and an amount of the brake fluid introduced from the wheel cylinder 5 into the internal reservoir 8 via the pressure reduction valve 24. This flow amount is proportional to a product of a differential pressure between an upstream side of the pressure reduction valve 24 (the pressure reduction hydraulic passage 14 on the wheel cylinder 5 side with respect to the pressure reduction valve 24) and a downstream side of the pressure reduction valve 24 (the pressure reduction hydraulic passage 14 on the internal reservoir 8 side with respect to the pressure reduction valve 24), and a time period during which the pressure reduction valve 24 is opened. The pressure in the internal reservoir 8 is approximately equal to the atmospheric pressure, whereby the above-described differential pressure is approximately equal to the wheel cylinder pressure. Therefore, the wheel cylinder pressure after the pressure increase valve 21 is actuated in the valve closing direction can be estimated from the wheel cylinder pressure when the pressure increase valve 21 is actuated in the valve closing direction and the time period during which the pressure reduction valve 24 is opened.

The pump 6 draws the brake fluid from the internal reservoir 8, and discharges the brake fluid to the supply hydraulic passage 11P via the discharge hydraulic passage 12. Since the shutoff valve 20P is actuated in the valve opening direction, the discharged brake fluid is returned to the supply hydraulic passage 11P on the primary chamber 41P side with respect to the shutoff valve 20P. A part of the returned brake fluid is introduced into the internal reservoir 8 after being transmitted through the first intake hydraulic passage 13, and is drawn by the pump 6 again. In this manner, the circulation hydraulic passage is formed. In this manner, the apparatus 1 controls the pressure reduction valve 24 in the valve opening direction to thereby reduce the pressure in the wheel cylinder 5 that is the control target wheel, and discharges the unnecessary brake fluid to the internal reservoir 8 to return this brake fluid to the master cylinder 4 side by the pump 6.

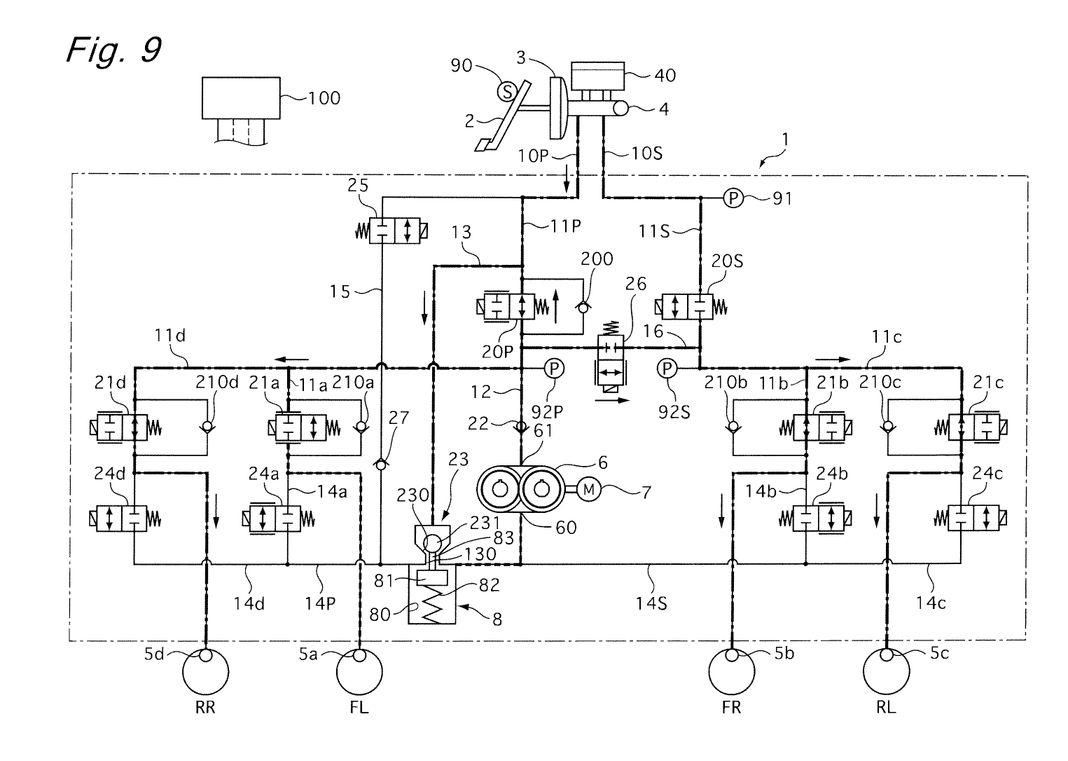

FIG. 9 illustrates the state of the apparatus 1 when the wheel cylinder pressure at the control target wheel FL is controlled so as to be maintained. Power is not supplied to the pressure reduction valve 24a corresponding to the wheel cylinder 5a on the control target wheel FL to actuate the valve 24a in the valve closing direction. The operations of the other actuators are similar to the operations during the pressure reduction control (FIG. 8). The brake fluid in the wheel cylinder 5a is confined in a hydraulic passage between this wheel cylinder 5a, the pressure increase valve 21a, and the pressure reduction valve 24a. As a result, the hydraulic pressure in the wheel cylinder 5a is maintained. The pump 6 is continuously rotated. The brake fluid returned from the shutoff valve 20P in the P system to the master cylinder 4 side is introduced into the internal reservoir 8 after being transmitted through the first intake hydraulic passage 13, and is drawn by the pump 6 again. In this manner, the circulation hydraulic passage is formed. The other operations are similar to the operations during the pressure reduction control (FIG. 8).

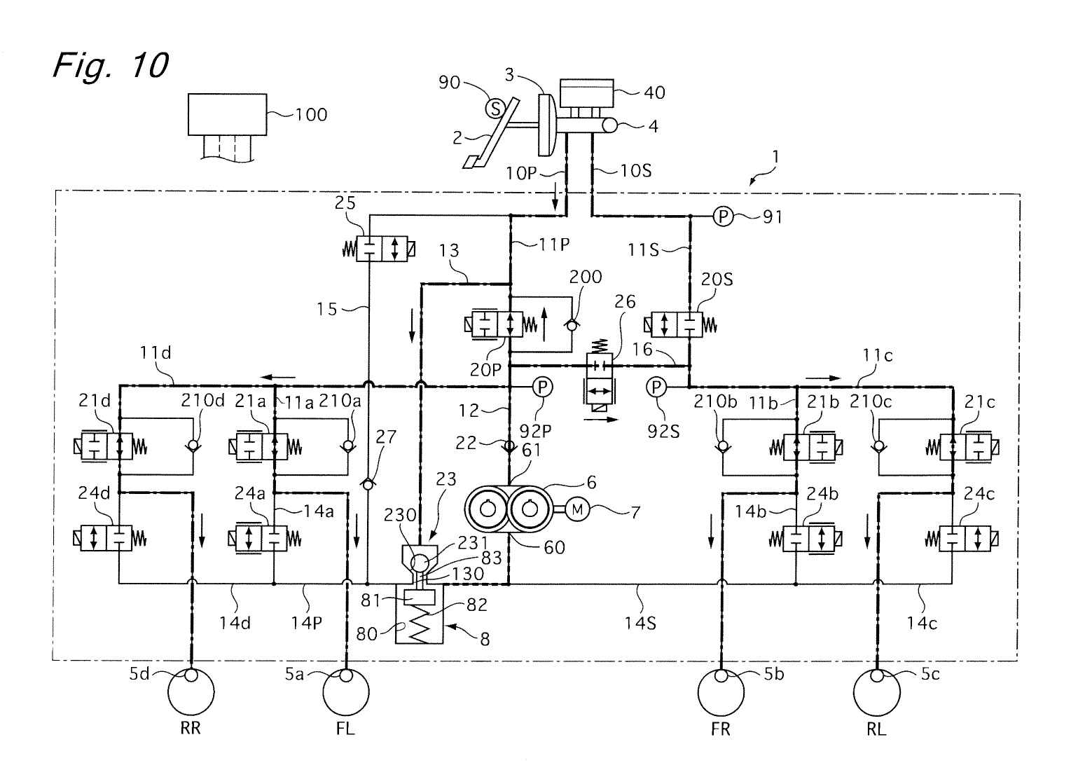

FIG. 10 illustrates the state of the apparatus 1 when the wheel cylinder pressure at the control target wheel is controlled so as to be increased. The power is not supplied to the pressure increase valve 21a corresponding to the wheel cylinder 5a on the control target wheel FL to actuate the valve 21a in the valve opening direction. The power is not supplied to the pressure reduction valve 24a corresponding to the wheel cylinder 5a to actuate the valve 24a in the valve closing direction. The operations of the other actuators are similar to the operations during the pressure reduction control (FIG. 8). The brake fluid from the primary chamber 41P is introduced into the wheel cylinder 5a after being transmitted through the supply hydraulic passage 11a (via the pressure increase valve 21a). As a result, the pressure in the wheel cylinder 5a is increased. The pump 6 is continuously rotated in a similar manner to the maintenance control (FIG. 9). In this manner, the circulation hydraulic passage is formed. The other operations are similar to the operations during the pressure reduction control (FIG. 8).

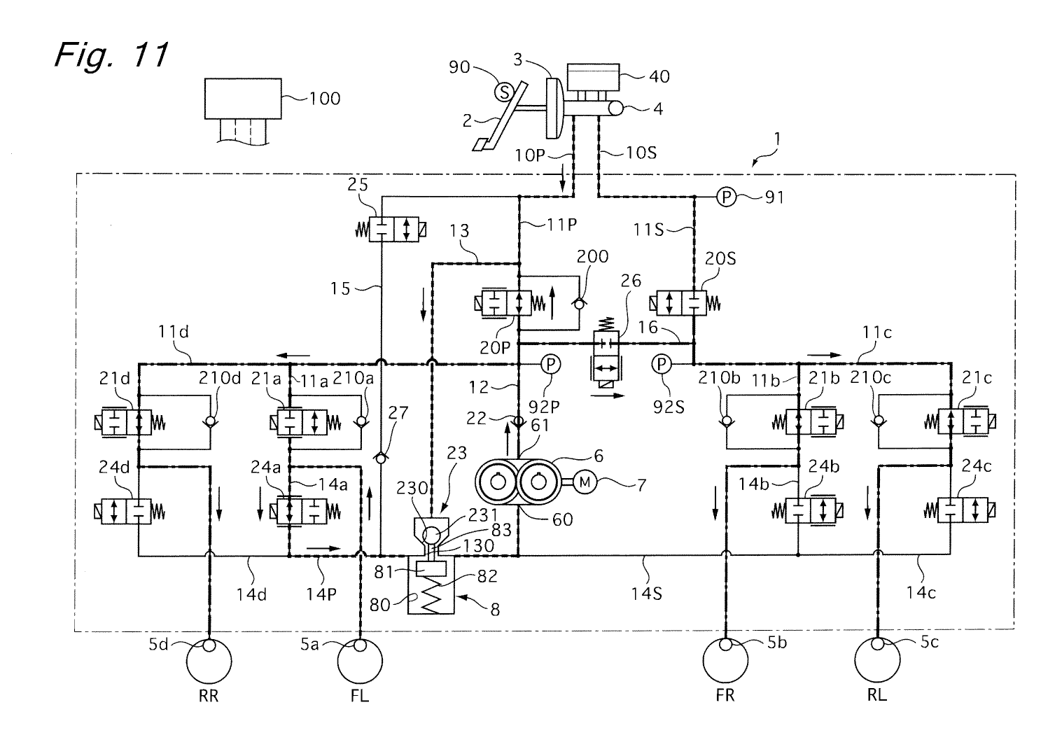

FIGS. 11 to 13 illustrate the state of the apparatus 1 during the ABS control when the master cylinder pressure is low. When the master cylinder pressure is low, the braking force (the wheel cylinder pressure) cannot be sufficiently generated only by the pressing force on the brake pedal 2 (the master cylinder pressures), so that the braking force is generated with use of the pump 6, and the master cylinder pressure is lower than the wheel cylinder pressure, in a similar manner to FIG. 5. Examples of a situation when the ABS control is exercised at such a time include the vehicle being running on a road surface having a high frictional coefficient (a high μ road and a dry asphalt road). This control will be referred to as ABS control 2. The hydraulic pressure in the wheel cylinder 5 that is the control target wheel is controlled by adjustments of the valve opened states of the pressure increase valve 21 and the pressure reduction valve 24 corresponding to this wheel cylinder 5. The hydraulic pressure in the wheel cylinder 5 that is not the control target wheel is generated by the brake fluid supplied from the pump 6, and is controlled by a leak of unnecessary fluid from the shutoff valve 20P in the P system.

FIG. 11 illustrates the state when the wheel cylinder pressure at the control target wheel is controlled so as to be reduced. The shutoff valve 20P in the P system is subjected to the PWM control, so that its valve opened state is controlled. Power is supplied to the shutoff valve 20S in the S system to actuate the valve 20S in the valve closing direction. The communication valve 26 is subjected to the PWM control, so that its valve opened state is controlled. The motor 7 is subjected to the PWM control, so that the amount discharged from the pump 6 is controlled. Power is supplied to the pressure increase valve 21a corresponding to the wheel cylinder 5a on the control target wheel FL to actuate the valve 21a in the valve closing direction. Power is supplied to the pressure reduction valve 24a corresponding to the wheel cylinder 5a to actuate the valve 24a in the valve opening direction. Power is not supplied to the other actuators. The brake fluid delivered from the wheel cylinder 5a toward the apparatus 1 is introduced into the internal reservoir 8 after being transmitted through the pressure reduction hydraulic passage 14a via the pressure reduction valve 24a. As a result, the pressure in the wheel cylinder 5a is reduced. The pump 6 draws the brake fluid from the internal reservoir 8, and discharges the brake fluid to the supply hydraulic passage 11P via the discharge hydraulic passage 12. The valve opened state of the shutoff valve 20P is controlled and the amount of the brake fluid discharged to the primary chamber 41P side via the shutoff valve 20P is adjusted, by which the pressure in the supply hydraulic passage 11P on the pump 6 side with respect to the shutoff valve 20P, and the pressure in the supply hydraulic passage 11S on the pressure increase valve 21 side with respect to the shutoff valve 20S are controlled. As a result, the hydraulic pressures in the other wheel cylinders 5b to 5d are controlled. A part of the brake fluid discharged to the primary chamber 41P side is introduced into the internal reservoir 8 via the first intake hydraulic passage 13, and is drawn by the pump 6 again. In this manner, the circulation hydraulic passage is formed.

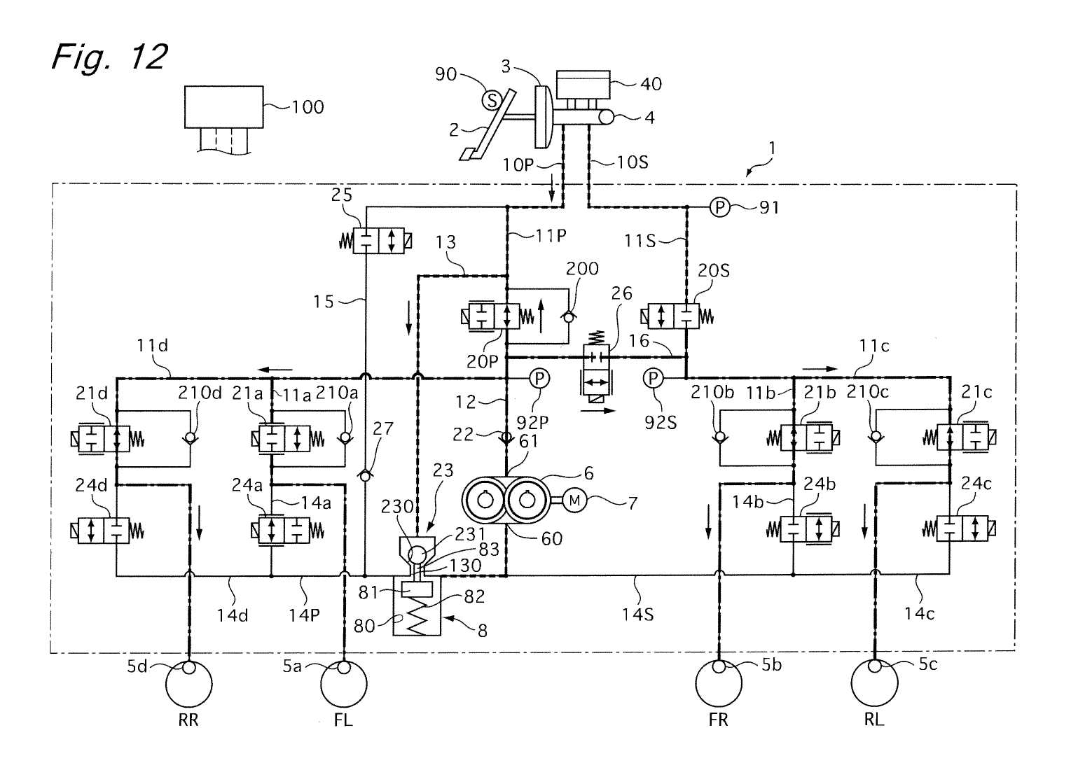

FIG. 12 illustrates the state of the apparatus 1 when the wheel cylinder pressure at the control target wheel is controlled so as to be maintained. Power is not supplied to the pressure reduction valve 24a corresponding to the wheel cylinder 5a on the control target wheel FL to actuate the valve 24a in the valve closing direction. The operations of the other actuators are similar to the operations during the pressure reduction control (FIG. 11). In a similar manner to the ABS control 1 (FIG. 9), the hydraulic pressure in the wheel cylinder 5a that is the control target is maintained, and the circulation hydraulic passage is formed. The other operations are similar to the operations during the pressure reduction control (FIG. 11).

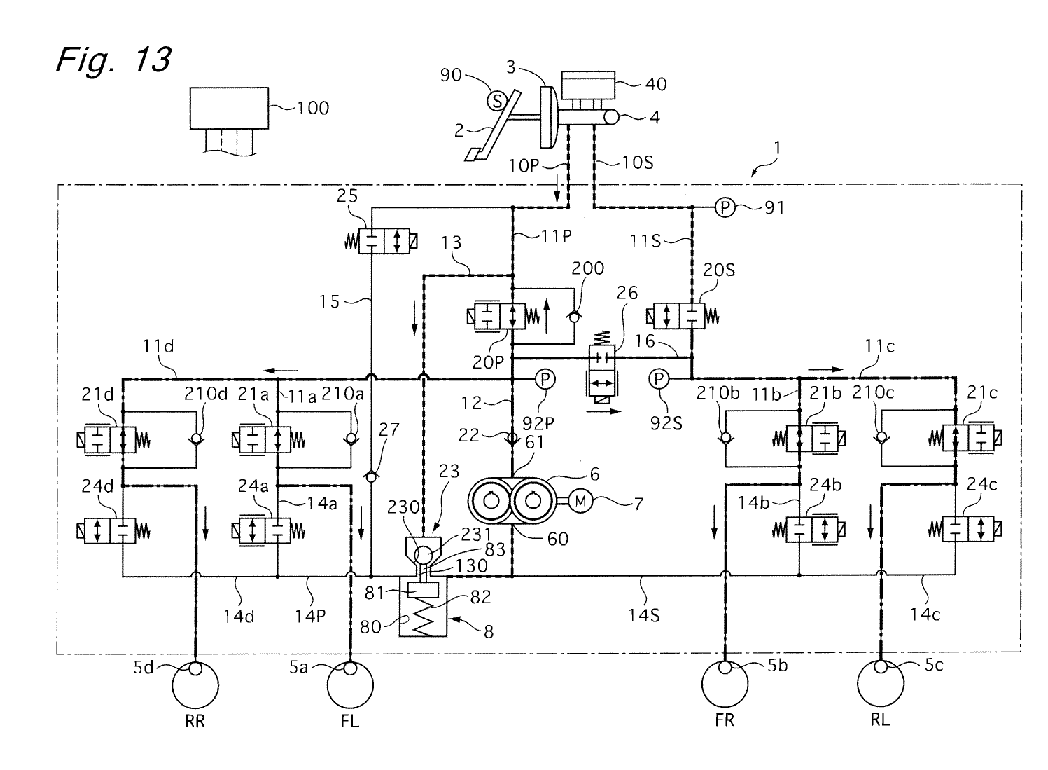

FIG. 13 illustrates the state of the apparatus 1 when the wheel cylinder pressure is controlled so as to be increased. Power is not supplied to the pressure increase valve 21a corresponding to the wheel cylinder 5a on the control target wheel FL to actuate the valve 21a in the valve opening direction. Power is not supplied to the pressure reduction valve 24a corresponding to the wheel cylinder 5a to actuate the valve 24a in the valve closing direction. The operations of the other actuators are similar to the operations during the pressure reduction control (FIG. 11). In a similar manner to the ABS control 1 (FIG. 10), the pressure in the wheel cylinder 5a that is the control target wheel is increased, and the circulation hydraulic passage is formed. The other operations are similar to the operations during the pressure reduction control (FIG. 11).

### (TCS Control)

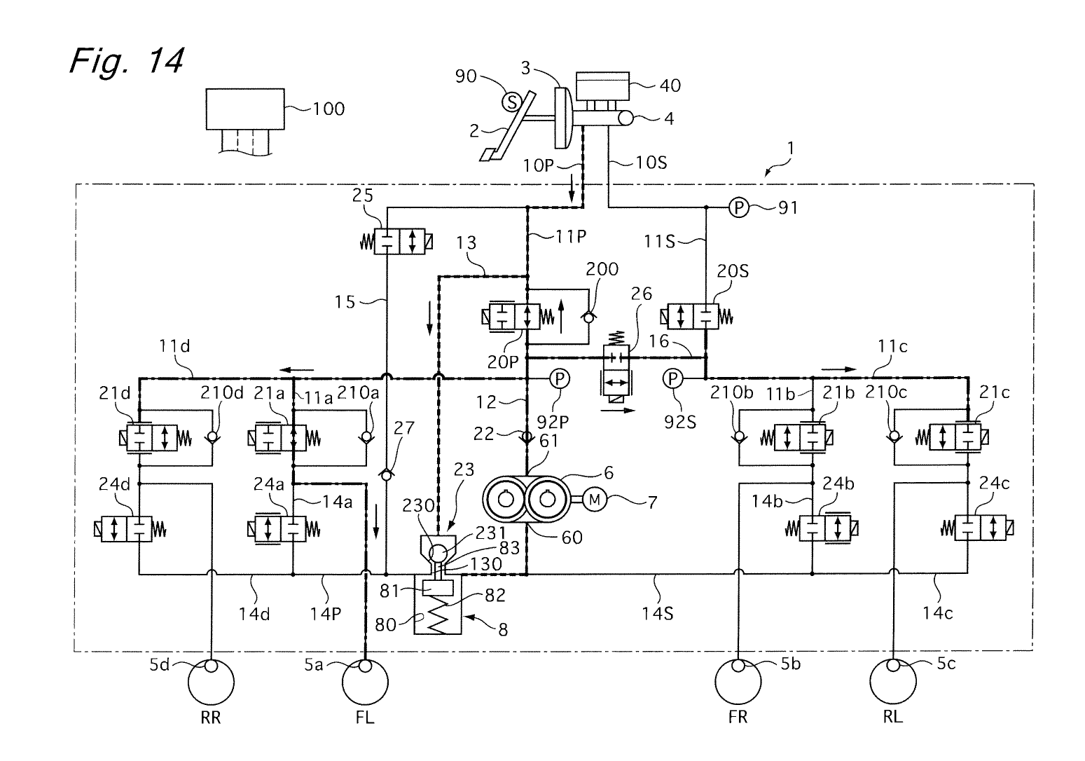

FIGS. 14 to 16 illustrate the state of the apparatus 1 when the TCS control is performed while the driver does not perform the braking operation. For example, when a slip amount of one of the driving wheels FL and FR is increased due to, for example, a difference in a road surface μ between the left side and the right side of the vehicle, a braking force for reducing this slip is generated on the one of the driving wheel FL and FR (the wheel that is the control target). By this control, the apparatus 1 exerts a so-called LSD function of reducing a slip due to a torque loss at a differential gear. The hydraulic pressure in the wheel cylinder 5 on the control target wheel is generated by the brake fluid supplied from the pump 6, and is controlled by a leak of unnecessary fluid from the shutoff valve 20P in the P system. The hydraulic pressures in the respective wheel cylinders 5 that are not the control target wheel are controlled by adjustments of the valve opened states of the pressure increase valves 21 and the pressure reduction valves 24 corresponding to the respective wheel cylinders 5.

FIG. 14 illustrates the state of the apparatus 1 when the wheel cylinder pressure at the control target wheel FL is controlled so as to be increased. The shutoff valve 20P in the P system is subjected to the PWM control, so that its valve opened state is controlled. Power is supplied to the shutoff valve 20S in the S system to actuate the valve 20S in the valve closing direction. The communication valve 26 is subjected to the PWM control, so that its valve opened state is controlled. The motor 7 is subjected to the PWM control, so that the amount discharged from the pump 6 is controlled. Power is supplied to the pressure increase valves 21b to 21d corresponding to the wheels FR to RR that are not the control target to actuate them in the valve closing directions. Power is not supplied to the other actuators. The pump 6 draws the brake fluid from the primary chamber 41P via the supply hydraulic passage 11P and the first intake hydraulic passage 13, and discharges the brake fluid to the supply hydraulic passage 11P via the discharge hydraulic passage 12. The valve opened state of the shutoff valve 20P is controlled and the amount of the brake fluid leaked from the pump 6 side to the primary chamber 41P side via the shutoff valve 20P is controlled, by which the pressure in the supply hydraulic passage 11P on the pump 6 side with respect to the shutoff valve 20P, and the pressure in the supply hydraulic passage 11S on the pressure increase valve 21 side with respect to the shutoff valve 20S are adjusted. Power is not supplied to the pressure increase valve 21a corresponding to the control target wheel FL to actuate the valve 21a in the valve opening direction, whereby the pressure in the supply hydraulic passage 11P on the pump 6 side with respect to the shutoff valve 20P is approximately equal to the hydraulic pressure in the wheel cylinder 5a on the control target wheel FL. The valve opened state of the shutoff valve 20P is controlled in such a manner that the amount of the fluid discharged from the pump 6 to the supply hydraulic passage 11P exceeds the amount of the fluid leaked from the pump 6 side to the primary chamber 41P side via the shutoff valve 20P, whereby the pressure in the wheel cylinder 5a is increased. A part of the brake fluid discharged to the primary chamber 41P side is introduced into the internal reservoir 8 via the first intake hydraulic passage 13, and is drawn by the pump 6 again. In this manner, the circulation hydraulic passage is formed. The hydraulic pressures in the respective wheel cylinders 5 that are not the control target wheel are not increased since the pressure increase valves 21 corresponding to the respective wheel cylinders 5 are actuated in the valve closing directions.

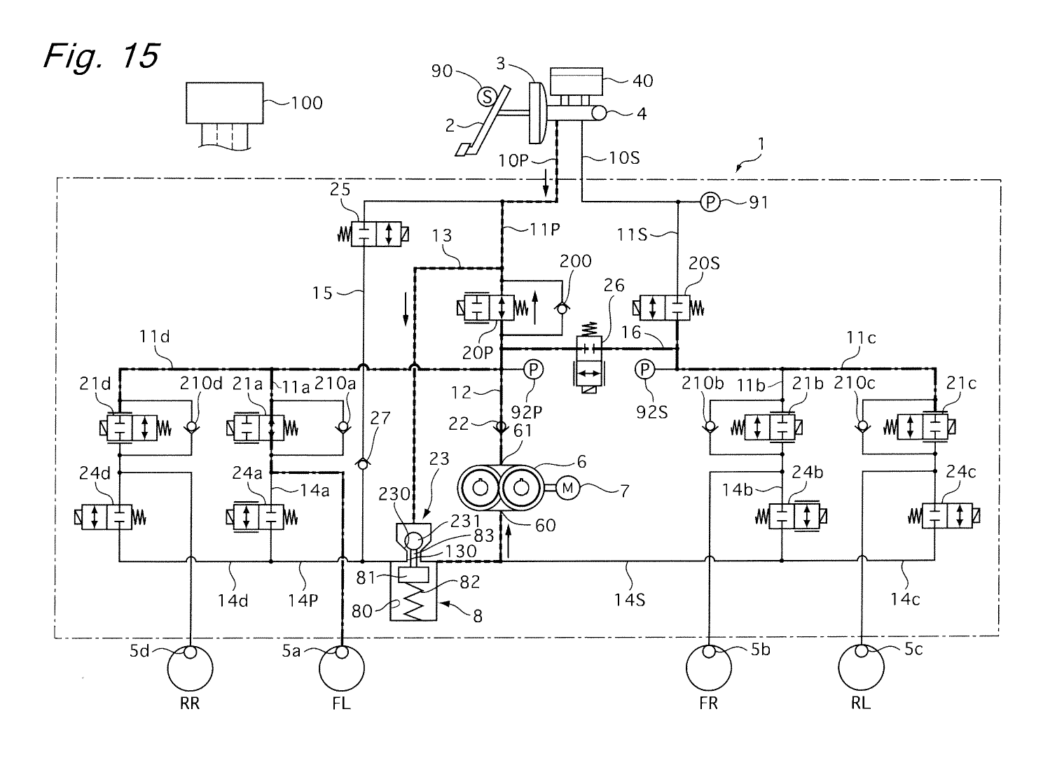

FIG. 15 illustrates the state of the apparatus 1 when the wheel cylinder pressure at the control target wheel FL is controlled so as to be maintained. The operations of the actuators are similar to the operations during the pressure increase control (FIG. 14). The valve opened state of the shutoff valve 20P is controlled in such a manner that the amount of the fluid discharged from the pump 6 to the supply hydraulic passage 11P approximately matches the amount of the fluid leaked from the pump 6 side to the primary chamber 41P side via the shutoff valve 20P, by which the hydraulic pressure in the wheel cylinder 5a on the control target wheel FL is maintained. The other operations are similar to the operations during the pressure increase control (FIG. 14).

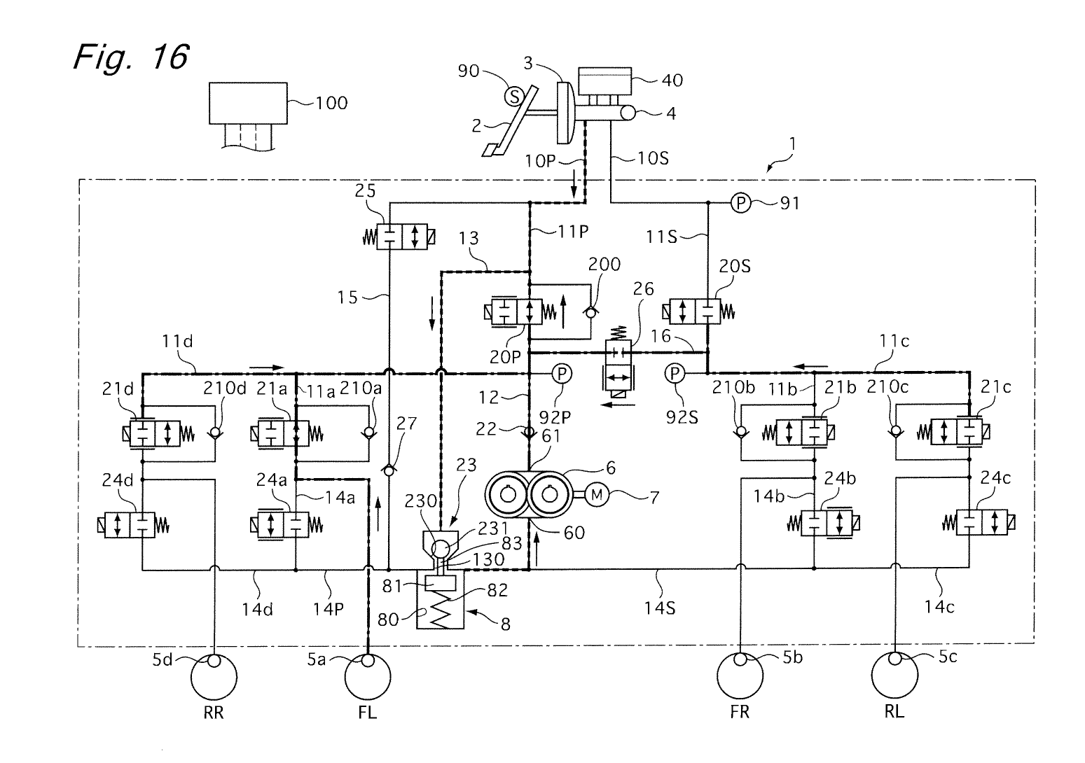

FIG. 16 illustrates the state of the apparatus 1 when the wheel cylinder pressure at the control target wheel FL is controlled so as to be reduced. The operations of the actuators are similar to the operations during the pressure increase control (FIG. 14). The valve opened state of the shutoff valve 20P is controlled in such a manner that the amount of the fluid discharged from the pump 6 to the supply hydraulic passage 11P falls below the amount of the fluid leaked from the pump 6 side to the primary chamber 41P side via the shutoff valve 20P, by which the pressure in the wheel cylinder 5a is reduced. The other operations are similar to the operations during the pressure increase control (FIG. 14).

### (VDC Control)

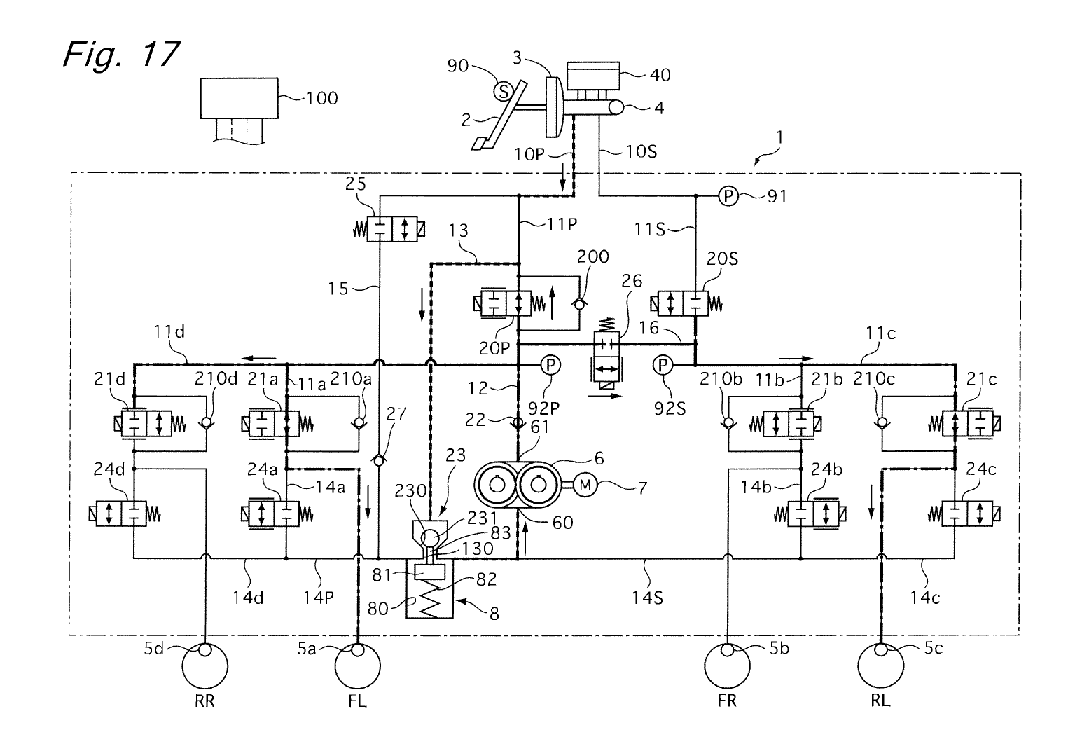

FIGS. 17 to 22 illustrate the state of the apparatus 1 when the VDC control is performed while the driver does not perform the braking operation. This case corresponds to, for example, control of the hydraulic braking forces (the wheel cylinder pressures) of two wheels serving as wheels located on an outer side in a turn when the vehicle is turning a corner.

FIGS. 17 to 19 illustrate the state of the apparatus 1 when the hydraulic pressures in the wheel cylinders 5a and 5c on the two control target wheels FL and RL are controlled so as to approximately match each other. Hereinafter, this control will be referred to as VDC control 1. In a similar manner to the TCS control, the hydraulic pressures in the wheel cylinders 5a and 5c on the control target wheels FL and RL are generated by the brake fluid supplied from the pump 6, and are controlled by a leak of unnecessary fluid from the shutoff valve 20P in the P system. The hydraulic pressures in the wheel cylinders 5b and 5d on the wheels FR and FF that are not the control target wheels are controlled by adjustments of the valve opened states of the pressure increase valves 21 and the pressure reduction valves 24 corresponding to the respective wheel cylinders 5.

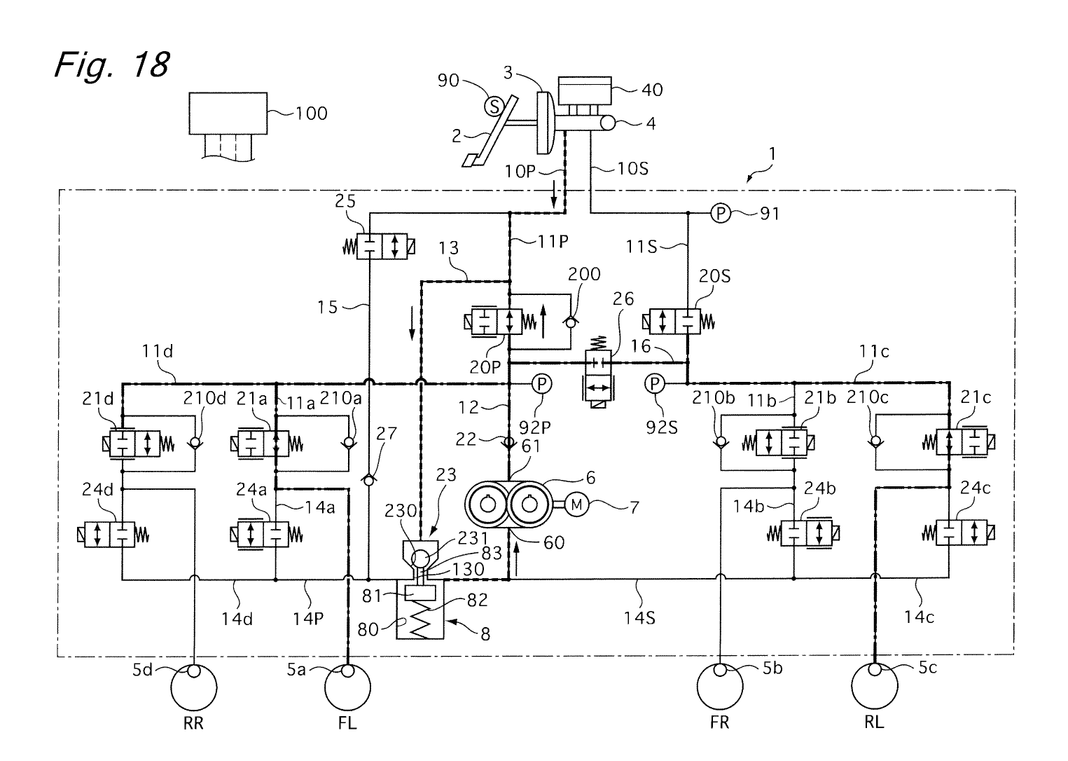

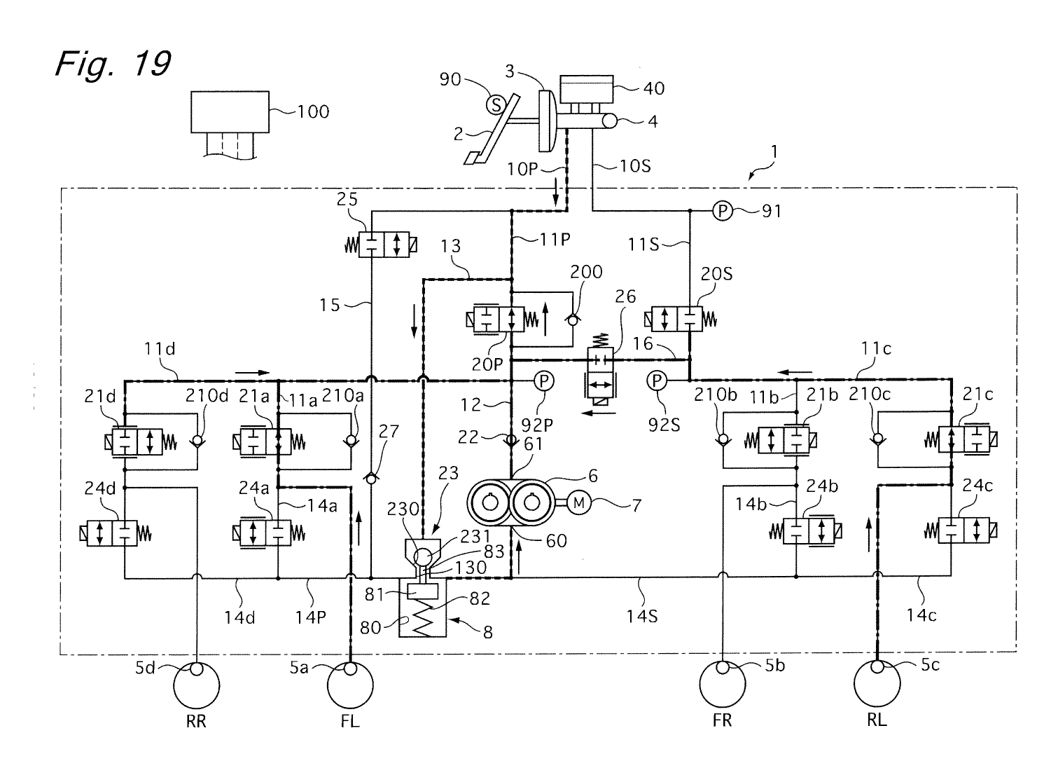

FIG. 17 illustrates the state of the apparatus 1 when the wheel cylinder pressures at the control target wheels FL and RL are controlled so as to be increased. The actuation of the actuators and the operations for generating the brake hydraulic pressures are similar to those during the TCS control (FIG. 14). The pressures in the wheel cylinders 5a and 5c on the two wheels FL and RL that are the control targets are approximately equally increased. FIG. 18 illustrates the state of the apparatus 1 when the wheel cylinder pressures at the control target wheels FL and RL are controlled so as to be maintained. The actuation of the actuators and the operations for generating the brake hydraulic pressures are similar to those during the TCS control (FIG. 15). The pressures in the wheel cylinders 5a and 5c are approximately equally maintained. FIG. 19 illustrates the state of the apparatus 1 when the wheel cylinder pressures at the control target wheels FL and RL are controlled so as to be reduced. The actuation of the actuators and the operations for generating the brake hydraulic pressures are similar to those during the TCS control (FIG. 16). The pressures in the wheel cylinders 5a and 5c are approximately equally reduced.

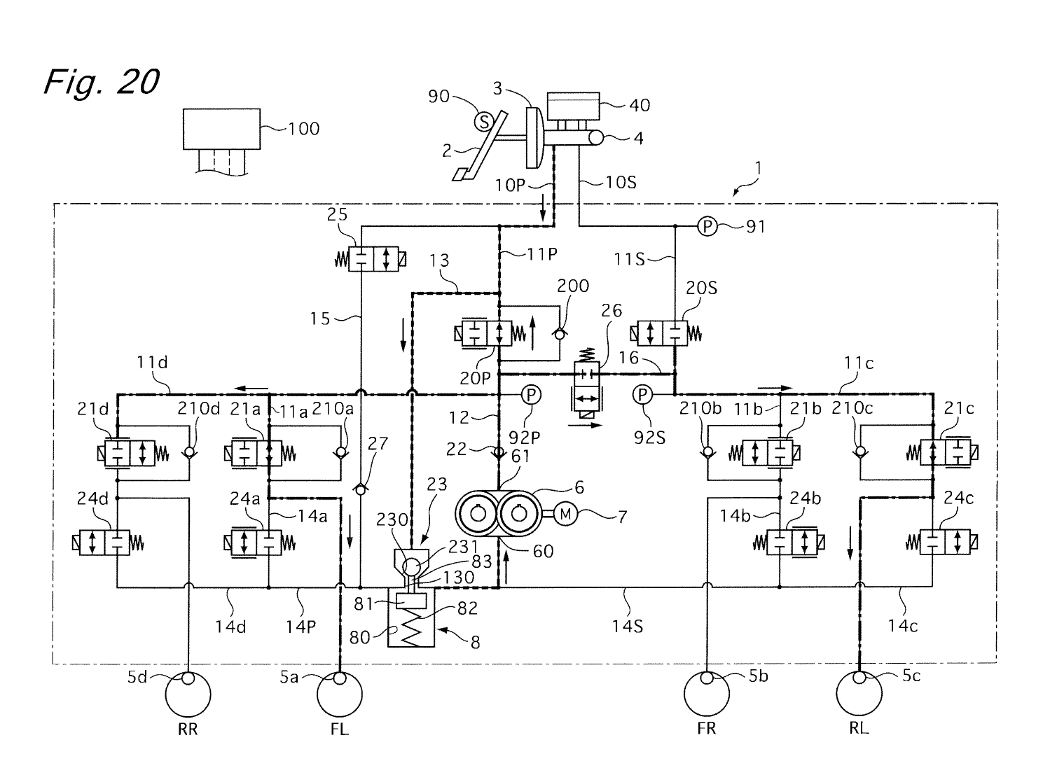

FIGS. 20 to 22 illustrate the state of the apparatus 1 when the hydraulic pressures in the wheel cylinders 5a and 5c on the two control target wheels FL and RL are controlled to different values. This control will be referred to as VDC control 2. For example, this control is control of generating a high wheel cylinder pressure on the front wheel FL side and generating a low wheel cylinder pressure on the rear wheel RL side when the rear wheel RL is prone to be locked because, for example, a load is lighter on the rear wheel RL side than on the front wheel FL side. The hydraulic pressure in the wheel cylinder 5a on the front left wheel FL of the control target wheels FL and RL that is supposed to have a high pressure is generated by the brake fluid supplied from the pump 6, and is controlled by a leak of unnecessary fluid from the shutoff valve 20P in the P system, in a similar manner to the VDC control 1. The hydraulic pressure in the wheel cylinder 5c on the rear left wheel RL of the control target wheels FL and RL that is supposed to have a low pressure, and the hydraulic pressures in the wheel cylinders 5b and 5d on the wheels FR and RR that are not the control target wheels are controlled by adjustments of the valve opened states of the pressure increase valves 21 and the pressure reduction valves 24 corresponding to the respective wheel cylinders 5.

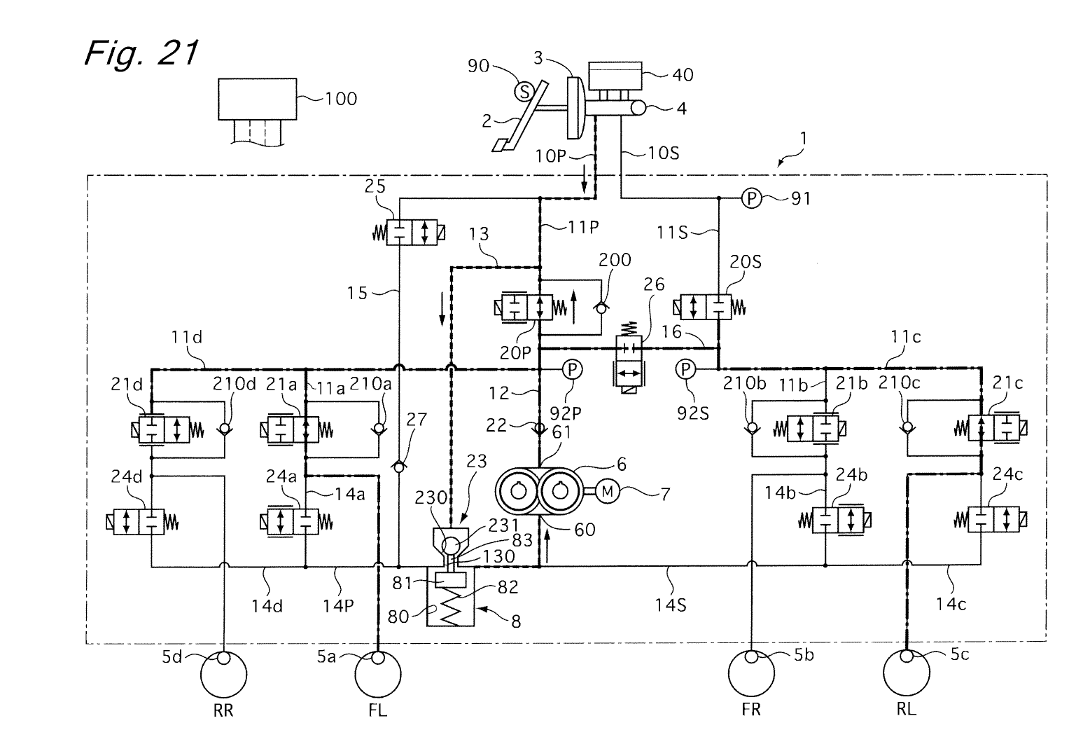

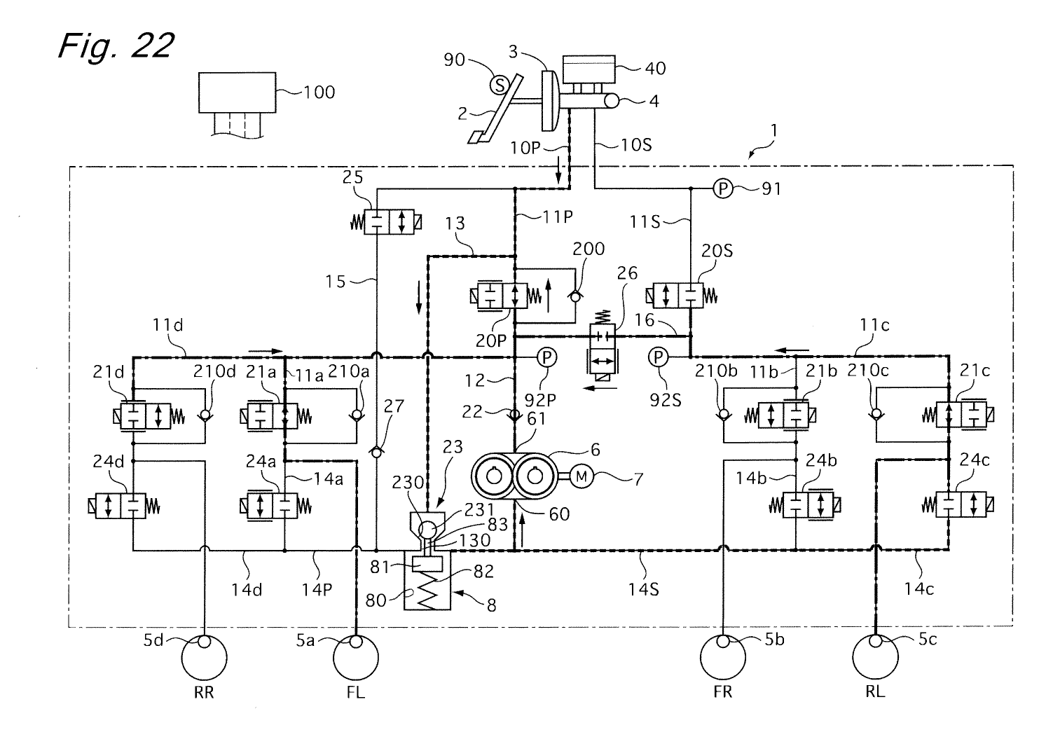

FIG. 20 illustrates the state of the apparatus 1 when the wheel cylinder pressures in the two control target wheels FL and RL are controlled so as to be increased. The pressure increase valve 21c corresponding to the control target wheel RL on the low pressure side is subjected to the PWM control, so that its valve opened state is controlled. The actuation of the other actuators is similar to the actuation during the VDC control 1 (FIG. 17). The hydraulic pressure in the wheel cylinder 5c supposed to have a low pressure is controlled to a lower pressure than the hydraulic pressure in the wheel cylinder 5a supposed to have a high pressure by control of the valve opened state of the pressure increase valve 21c corresponding to the wheel cylinder 5c. The other operations are similar to the operations during the VDC control 1 (FIG. 17). FIG. 21 illustrates the state of the apparatus 1 when the wheel cylinder pressures at the two control target wheels FL and RL are controlled so as to be maintained. The pressure increase valve 21c corresponding to the control target wheel RL on the low pressure side is subjected to the PWM control, so that its valve opened state is controlled. The actuation of the other actuators is similar to the actuation during the VDC control 1 (FIG. 18). The hydraulic pressure in the wheel cylinder 5c supposed to have a low pressure is maintained at a lower pressure than the hydraulic pressure in the wheel cylinder 5a supposed to have a high pressure by control of the valve opened state of the pressure increase valve 21c corresponding to the wheel cylinder 5c. The other operations are similar to the operations during the VDC control 1 (FIG. 18). FIG. 22 illustrates the state of the apparatus 1 when the wheel cylinder pressures at the two control target wheels FL and RL are controlled so as to be reduced. The pressure increase valve 21c and the pressure reduction valve 24c corresponding to the control target wheel RL on the low pressure side are respectively subjected to the PWM control, so that their valve opened states are controlled. The actuation of the other actuators is similar to the actuation during the VDC control 1 (FIG. 19). The hydraulic pressure in the wheel cylinder 5c supposed to have a low pressure is reduced to a lower pressure than the hydraulic pressure in the wheel cylinder 5a supposed to have a high pressure by control of the valve opened states of the pressure increase valve 21c and the pressure reduction valve 24c corresponding to the wheel cylinder 5c. The brake fluid discharged from the wheel cylinder 5c to the pressure reduction hydraulic passage 14c via the pressure reduction valve 24c is introduced into the internal reservoir 8 or is drawn by the pump 6. The other operations are similar to the operations during the VDC control 1 (FIG. 19). Regarding the control target wheel RL on the low pressure side, power may be supplied to the corresponding pressure increase valve 21c to actuate the valve 21c in the valve closing direction, and only the corresponding pressure reduction valve 24c may be subjected to the PWM control.

When the pressure in the wheel cylinder 5a of the two control target wheels FL and RL that is supposed to have a high pressure is controlled so as to be increased, and the pressure in the wheel cylinder 5c that is supposed to have a low pressure is controlled so as to be reduced, the brake fluid discharged from the wheel cylinder 5c on the wheel RL on the low pressure side via the pressure reduction vale 24c, or the brake fluid supplied from the first intake hydraulic passage 13 via the internal reservoir 8 is drawn by the pump 6 to be discharged to the supply hydraulic passage 11P. As a result, the pressure in the supply hydraulic passage 11P on the pump 6 side with respect to the shutoff valve 20P is increased, whereby the wheel cylinder pressure at the wheel FL on the high pressure side is increased. When the pressure increase amount is still insufficient, the amount of the fluid leaked from the supply hydraulic passage 11P on the pump 6 side to the primary chamber 41P side via the shutoff valve 20P is reduced, whereby the wheel cylinder pressure at the wheel FL on the high pressure side is further increased. Further, when the pressure in the wheel cylinder 5a of the two control target wheels FL and RL that is supposed to have a high pressure is controlled so as to be reduced, and the pressure in the wheel cylinder 5c supposed to have a low pressure is controlled so as to be increased, the brake fluid is supplied from the supply hydraulic passage 11P on the pump 6 side with respect to the shutoff valve 20P via the pressure increase valve 21c corresponding to the wheel cylinder 5c supposed to have a low pressure to this wheel cylinder 5c. As a result, the pressure in the supply hydraulic passage 11P on the pump 6 side with respect to the shutoff valve 20P is reduced, whereby the pressure in the wheel cylinder 5a on the wheel FL on the high pressure side is reduced. When the pressure reduction amount is still insufficient, the amount of the fluid leaked from the supply hydraulic passage 11P on the pump 6 side to the primary chamber 41P side via the shutoff valve 20P is increased, whereby the pressure in the wheel cylinder 5a on the wheel FL on the high pressure side is further reduced.

### (Failed System Identification Control)

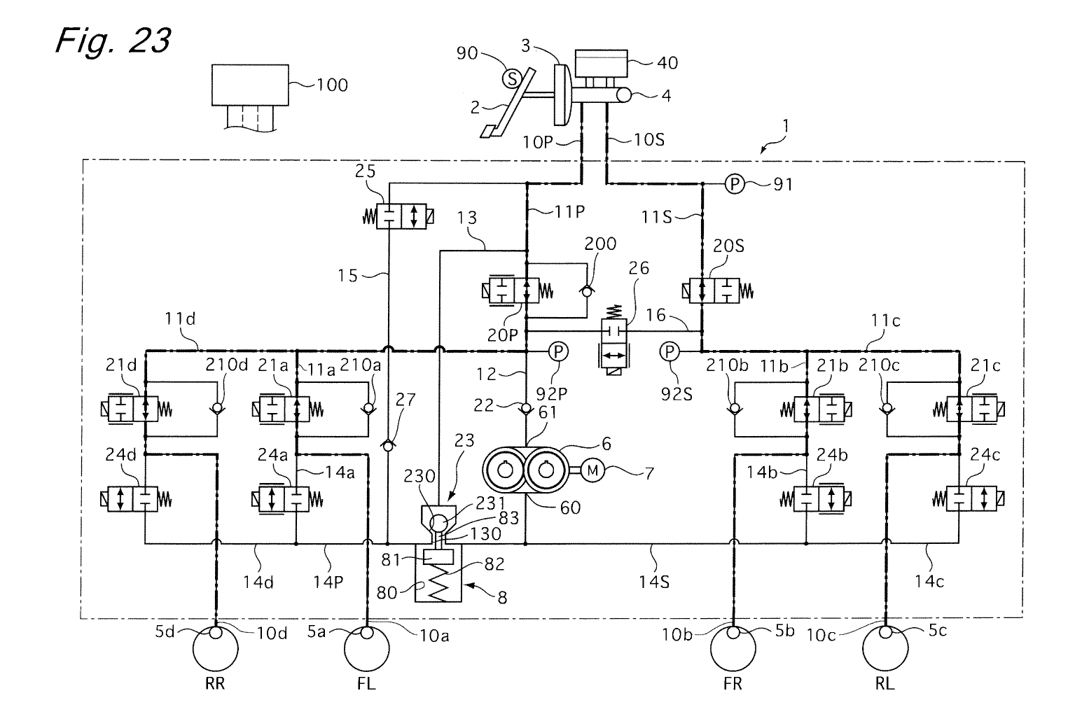

FIG. 23 illustrates the state of the apparatus 1 during failed system identification control. When the brake fluid is leaked outwardly from the brake system including the apparatus 1, or a malfunction occurs at the control valve in the apparatus 1, which leads to occurrence of a failure in generation of a sufficient wheel cylinder pressure, this control is used to identify which system has the failure. This identification control is carried out when the driver presses the brake pedal 2 in such a situation that the shutoff valve 20S in one of the systems does not have to be actuated in the valve closing direction (to establish balances between inputs and outputs of the fluid amounts in the respective chambers 41P and 41S in the master cylinder 4 as will be described below), i.e., in such a situation that the brake fluid can be supplied from the both systems to the respective wheel cylinders 5. More specifically, preferably, this control is carried out when the vehicle is stopped (except for a temporary stop during running), for example, when the system of the vehicle is started up.

More specifically, power is not supplied to the respective actuators in a similar manner to the operation when the brake is out of operation (FIG. 1). The brake fluid delivered from the primary chamber 41P toward the apparatus 1 according to pressing of the brake pedal 2 is supplied toward the wheel cylinders 5a and 5d after being transmitted through the supply hydraulic passage 11P via the shutoff valve 20P. The brake fluid delivered from the secondary chamber 41S toward the apparatus 1 is supplied toward the wheel cylinders 5b and 5c after being transmitted through the supply hydraulic passage 11S via the shutoff valve 20S. Since the communication valve 26 is actuated in the valve closing direction, the brake fluid is prohibited from flowing between the supply hydraulic passages 11P and 11S. The brake controller 100 identifies the failed system based on a value detected by the stroke sensor 90 and values detected by the three hydraulic sensors 91, 92P, and 92S in this state. The brake controller 100 compares a master cylinder pressure Pm detected by the hydraulic sensor 91, a hydraulic pressure Pp in the P system that is detected by the hydraulic sensor 92P, a hydraulic pressure Ps in the S system that is detected by the hydraulic sensor 92S, and a converted value Pst calculated by converting the pedal stroke detected by the stroke sensor 90 into a hydraulic pressure (a hydraulic pressure estimated to be generated in correspondence with the pedal stroke when no failure occurs). If the respective hydraulic pressures are approximately equal to one another (Pm=Pp=Ps=Pst), the brake controller 100 determines that the current state is a normal state in which any system does not have a failure. If the master cylinder pressure Pm and the hydraulic pressure Ps in the S system are approximately equal to each other, the hydraulic pressure Pp in the P system is lower than these hydraulic pressures Pm and Ps, and the pedal stroke-hydraulic pressure converted value Pst is higher than these hydraulic pressures Pm and Ps (Pst>Ps=Pm>Pp), the brake controller 100 determines that a failure occurs in the P system. If the master cylinder pressure Pm and the hydraulic pressure Ps in the S system are approximately equal to each other, the hydraulic pressure Pp in the P system is higher than these hydraulic pressures Pm and Ps, and the pedal stroke-hydraulic pressure converted value Pst is higher than the hydraulic pressure Pp in the P system (Pst>Pp>Ps=Pm), the brake controller 100 determines that a failure occurs in the S system.

Examples of a possible failure occurring in the P system include a leak of the fluid from the brake pipe 10P connecting the master cylinder 4 (the primary chamber 41P) and the apparatus 1 (the supply hydraulic passage 11P) to each other (due to, for example, detachment of the pipe), a leak of the fluid from any of the brake pipes 10a and 10d connecting the wheel cylinders 5a and 5d and the apparatus 1 (the supply hydraulic passages 11a and 11d) to each other (due to, for example, detachment of the pipe), any of the pressure reduction valves 24a and 24d stuck in the valve opened state, and the check valve 23 stuck in the valve opened state. When any of these failures occurs, the brake fluid in the primary chamber 41P is leaked outwardly from the brake system or into the internal reservoir 8, whereby the hydraulic pressure Pp in the P system is not increased (is maintained at the approximately atmospheric pressure) regardless of the pedal stroke. On the other hand, when the secondary piston 42S in the master cylinder 4 performs a stroke beyond the first piston seal 441S in a direction for reducing the volume of the secondary chamber 41S, a higher hydraulic pressure than the atmospheric pressure (the hydraulic pressure Pp in the P system) is generated and is transmitted to the wheel cylinders 5b and 5c. (The brake fluid in the space 46S on the S system side is maintained due to the partition member 45 illustrated in FIG. 2 even with a reduction in the brake fluid in the space 46P on the P system side in the reservoir tank 40.) This hydraulic pressure is detected as the master cylinder pressure Pm and the hydraulic pressure Ps in the S system. The hydraulic pressure in the primary chamber 41P is not increased (is maintained at the approximately atmospheric pressure), whereby a reaction force applied from the primary chamber 41P to the secondary piston 42S is reduced. Accordingly, the hydraulic pressure in the secondary chamber 41S (the master cylinder pressure Pm and the hydraulic pressure Ps in the S system) falls below the pedal stroke-hydraulic pressure converted value Pst. Therefore, the pressures have the following magnitude relationship between them; Pst>Ps=Pm>Pp.

Examples of a possible failure occurring in the S system include a leak of the fluid from the brake pipe 10S connecting the master cylinder 4 (the secondary chamber 41S) and the apparatus 1 (the supply hydraulic passage 11S) to each other (due to for example, detachment of the pipe), a leak of the fluid from any of the brake pipes 10b and 10c connecting the wheel cylinders 5b and 5c and the apparatus 1 (the supply hydraulic passages 11b and 11c) to each other (due to, for example, detachment of the pipe), and any of the pressure reduction valves 24b and 24c stuck in the valve opened state. When any of these failures occurs, the brake fluid in the secondary chamber 41S is leaked outwardly from the brake system or into the internal reservoir 8, whereby the hydraulic pressure Ps in the S system and the master cylinder pressure Pm are not increased (are maintained at the approximately atmospheric pressures) regardless of the pedal stroke. On the other hand, when the primary piston 42P in the master cylinder 4 performs a stroke beyond the first piston seal 441P in a direction for reducing the volume of the primary chamber 41P, a higher hydraulic pressure than the atmospheric pressure (the master cylinder pressure Pm and the hydraulic pressure Ps in the S system) is generated and is transmitted to the wheel cylinders 5a and 5d. (The brake fluid in the space 46P on the P system side is maintained due to the partition member 45 illustrated in FIG. 2 even with a reduction in brake fluid in the space 46S on the S system side in the reservoir tank 40.) This hydraulic pressure is detected as the hydraulic pressure Pp in the P system. The hydraulic pressure in the secondary chamber 41S is not increased (is maintained at the approximately atmospheric pressure), whereby a reaction force applied from the secondary chamber 41S to the secondary piston 42S is reduced. Accordingly, the hydraulic pressure in the primary chamber 41P (the hydraulic pressure Pp in the P system) falls below the pedal stroke-hydraulic pressure converted value Pst. Therefore, the pressures have the following magnitude relationship between them; Pst>Pp>Ps=Pm.

Next, effects of the apparatus 1 will be described. Conventionally, there has been known a brake apparatus including two hydraulic passage systems, and a hydraulic source capable of increasing a hydraulic pressure in a wheel cylinder with use of brake fluid in a master cylinder. The apparatus 1 according to the present embodiment is configured to use the pump 6 as the above-described hydraulic source, and include the normally-opened electromagnetic valves (the shutoff valves 20) in the supply hydraulic passages 11 connecting the master cylinder 4 and the wheel cylinders 5 to control the valve opened states of the shutoff valves 20. The control of the shutoff valves 20 allows the hydraulic pressure in the hydraulic passage on the discharge side of the pump 6 to be adjusted independently of the hydraulic pressures in the hydraulic passages on the master cylinder 4 side, thereby facilitating control of the wheel cylinder pressures independently of the driver's braking operation. For example, it is possible to acquire desired hydraulic braking forces by controlling the number of rotations of the pump 6 and the valve opened states of the electromagnetic valves such as the shutoff valves 20 so as to achieve the target wheel cylinder pressures based on, for example, the values detected by the hydraulic sensors 92. In the present embodiment, basically, the apparatus 1 controls the electromagnetic valves (such as the shutoff valves 20) instead of the pump 6, thereby controlling the wheel cylinder pressures with excellent responsiveness. The shutoff valves 20 and the like are configured as the proportional control valves, which allows the apparatus 1 to perform precise control to realize smooth control of the wheel cylinder pressures.

The pump 6 is the rotational gear pump (the gear pump). Therefore, it is possible to ensure that the apparatus 1 operates quietly. Especially, in the case of employment of a control configuration highly frequently operating the pump 6 that performs the boosting assist control to actuate the pump 6 even during the normal brake control, like the apparatus 1, the present embodiment can effectively improve its anti-noise performance. More specifically, there is a trend to configure negative pressure boosters on small passenger vehicles and the like so as to operate based on a low negative pressure for the purpose of improving the fuel efficiency. Configuring the negative pressure booster so as to operate based on a low negative pressure results in a reduction in the boosting ratio of the negative pressure booster, thereby leading to reductions in the wheel cylinder pressures (the master cylinder pressures) generated with respect to the pressing force. Therefore, the reductions in the wheel cylinder pressures with respect to the pressing force should be compensated for with use of the hydraulic source (the boosting assist control). The apparatus 1 according to the present embodiment uses the pump 6 originally mounted on the unit to perform the ABS control and the VDC (or the ESC) control as the above-described hydraulic source, thereby succeeding in simplification of the configuration. Then, in a case where a plunger pump is used, like the conventional technique, the pump emits a large operation noise when increasing the pressure. On the other hand, the apparatus 1 according to the present embodiment uses the gear pump 6, which makes the apparatus 1 advantageous in terms of the anti-noise performance.

However, a configuration including the hydraulic source (the pump) for each system, like the conventional apparatus, may lead to an increase in the number of parts. For example, employing a unit including a plurality of pumps, for example, employing a tandem type gear pump unit, and using each pump in correspondence with one system leads to an increase in the number of parts and thus an increase in the cost. On the other hand, the apparatus 1 according to the present embodiment uses the single type gear pump 6 (i.e., includes a single pump) as the hydraulic source. This pump 6 is connected so as to be able to supply the brake fluid to the supply hydraulic passages 11P and 11S of the respective systems. Therefore, the pump 6 (the hydraulic source) does not have to be prepared for each of the systems P and S, which can avoid the increase in the number of parts. Further, this can also avoid increases in the size and the cost of the apparatus 1.

As the configuration that allows the pump 6 to supply the brake fluid to the supply hydraulic passages 11P and 11S of the respective systems, one possible configuration is disposing the pump 6 independently of the respective systems. On the other hand, the present embodiment is configured in such a manner that the pump 6 is included in the P system (the hydraulic passage therein), or is included in the supply hydraulic passage 11P. The apparatus 1 can be configured simply by including the pump 6 in one of the systems (the hydraulic passage therein) in this manner, instead of disposing the pump 6 independently of the respective systems. The pump 6 may be included in the S system, instead of the P system.

The apparatus 1 includes the connection hydraulic passage 16 connecting the supply hydraulic passages 11P and 11S to each other. The supply hydraulic passages 11P and 11S of the both systems are in communication with each other via the connection hydraulic passage 16. Therefore, even in the configuration where the pump 6 is included in one of the systems (the P system or the supply hydraulic passage 11P), the pump 6 can easily supply the brake fluid (pressure) to the other of the systems (the S system or the supply hydraulic passage 11S).

The apparatus 1 includes the communication valve 26 in the connection hydraulic passage 16. The apparatus 1 can separate the both systems from each other by actuating the communication valve 26 in the valve closing direction when a failure such as a fluid leak occurs. As a result, it is possible to improve the reliability of the apparatus 1. For example, when determining that a fluid leak occurs in one of the systems, the apparatus 1 actuates the communication valve 26 in the valve closing direction. As a result, the both systems are out of communication with each other via the connection hydraulic passage 16, whereby the pressures in the wheel cylinders 5 can be increased at least by the master cylinder pressure in the other of the systems in which the fluid leak does not occur. In the present embodiment, the communication valve 26 is configured as the normally-closed valve, and therefore can be automatically actuated in the valve closing direction when a failure occurs in a power supply. Therefore, it is possible to improve the reliability of the apparatus 1 when a failure occurs in a power supply. When determining that the fluid is leaked from any of the brake pipes 10a to 10d connecting the wheel cylinder 5 on a certain wheel and the apparatus 1 to each other, actuating the pressure increase valve 21 corresponding to this wheel in the valve closing direction allows the pressures in the wheel cylinders 5 on the other wheels to be increased by the pump 6 and the like.

The apparatus 1 includes the internal reservoir 8. The internal reservoir 8 is connected to the wheel cylinders 5 via the pressure reduction hydraulic passages 14, and is also connected to the intake portion 60 of the pump 6 via the first intake hydraulic passage 13. Therefore, during the ABS control, the apparatus 1 can control the pressure in the wheel cylinder 5 so as to reduce this pressure by discharging the brake fluid from the wheel cylinder 5 to store the discharged brake fluid into the internal reservoir 8. Further, the pump 6 can draw the brake fluid introduced into the internal reservoir 8 by the pressure reduction control, and return the brake fluid to the master cylinder 4 side. In the apparatus 1 according to the present embodiment, the internal reservoir 8 is connected to the pressure reduction hydraulic passages 14P and 14S in the respective systems so as to be able to receive the brake fluid, whereby the brake fluid discharged from the respective wheel cylinders 5a to 5d are introduced into the internal reservoir 8. Therefore, the internal reservoir 8 does not have to be prepared for each system, which can avoid the increase in the number of parts. Further, this can also avoid the increases in the size and the cost of the apparatus 1.

As the configuration that allows the internal reservoir 8 to receive the brake fluid from the pressure reduction hydraulic passages 14P and 14S in the respective systems, one possible configuration is preparing the internal reservoir 8 independently of the respective systems. On the other hand, the present embodiment is configured in such a manner that the internal reservoir 8 is included in the P system (the hydraulic passage therein). The apparatus 1 can be configured simply by including the internal reservoir 8 in one of the systems (the hydraulic passage therein) in this manner, instead of disposing the internal reservoir 8 independently of the respective systems. The internal reservoir 8 may be included in the S system, instead of the P system. In the present embodiment, the internal reservoir 8 is included in the P system, whereby, for example, the internal reservoir 8 can be disposed in the first intake hydraulic passage 13, and can be configured to have the pressure adjustment function including the check valve 23. This can simplify the configuration of the apparatus 1.

The second intake hydraulic passage 15 is provided in parallel with the first intake hydraulic passage 13. One end side of the second intake hydraulic passage 15 is in communication with the primary chamber 41P in the master cylinder 4, and an opposite end side of the second intake hydraulic passage 15 is in communication with the internal reservoir 8. The intake valve 25 is disposed in the second intake hydraulic passage 15. Therefore, during the boosting assist control and the regenerative coordination brake control, it is possible to prevent deterioration of the characteristic of a relationship of the wheel cylinder pressures and the master cylinder pressures to the pressing force and the pedal stroke. As a result, it is possible to prevent deterioration of an operation feeling (a pedal feeling) of the brake pedal 2. For example, during the normal brake control, when the brake pedal 2 starts to be pressed, the apparatus 1 actuates the intake valve 25 in the valve opening direction to thereby store the brake fluid from the primary chamber 41P into the internal reservoir 8 via the second intake hydraulic passage 15. When the brake pedal 2 is pressed to a certain degree so that the apparatus 1 performs the boosting assist control, the pump 6 draws the above-described stored brake fluid to discharge the brake fluid, thereby increasing the pressures in the wheel cylinders 5. As a result, it is possible to prevent occurrence of such a phenomenon that the brake fluid in the primary chamber 41P is suddenly reduced so that the brake pedal 2 is pulled in. Therefore, it is possible to prevent the deterioration of the pedal feeling. Further, during the regenerative coordination brake control (including execution of only the regenerative braking), the apparatus 1 actuates the intake valve 25 in the valve opening direction to thereby introduce the brake fluid from the primary chamber 41P into the internal reservoir 8 via the second intake hydraulic passage 15. In other words, the apparatus 1 introduces the brake fluid that becomes unnecessary due to execution of the regenerative braking into the internal reservoir 8, thereby using the internal reservoir 8 as a so-called stroke simulator. This permits the driver to perform a pedal stroke. Therefore, it is possible to prevent deterioration of the pedal feeling.

The discharge hydraulic passage 12, a part of the supply hydraulic passage 11P (including the shutoff valve 20P), and the first intake hydraulic passage 13 form the circulation hydraulic passage for returning the brake fluid supplied from the pump 6 to the supply hydraulic passage 11P (and the supply hydraulic passage 11S) to the pump 6 again. Circulating the brake fluid via the circulation hydraulic passage allows the pump 6 to be continuously rotated while preventing unnecessary brake fluid from being supplied to the wheel cylinders 5 and the master cylinder 4, thereby facilitating adjustments of the hydraulic pressures therein to desired values. Therefore, it is possible to ensure that the pump 6 operates with excellent responsiveness and that the pressures in the wheel cylinders 5 can be increased with excellent responsiveness. For example, during the regenerative cooperation brake control, the pump 6 is continuously rotated, which ensures that the pressures in the wheel cylinders 5 can be increased with improved responsiveness at the end of the regenerative braking. In a case where an electromagnetic valve for switching communication and discommunication of the first intake hydraulic passage 13 is disposed between the connection point of the first intake hydraulic passage 13 to the supply hydraulic passage 11P and the internal reservoir 8 instead of the check valve 23, it is possible to acquire a similar effect by actuating this electromagnetic valve in the valve closing direction to thereby continuously rotate the pump 6 even without circulating the brake fluid in the above-described manner.

When the hydraulic pressure is generated in the secondary chamber 41S in the master cylinder 4, the apparatus 1 basically actuates the shutoff valve 20S in the S system in the valve closing direction. As a result, the brake fluid is prevented from flowing out from the secondary chamber 41S in the master cylinder 4. For example, when the boosting assist control is not performed during the normal brake control with the pump 6 out of operation, the apparatus 1 actuates the shutoff valve 20S in the S system in the valve closing direction except when the brake pedal 2 starts to be pressed. As a result, the brake fluid flows out only from the primary chamber 41P to be supplied to the respective wheel cylinders 5. Further, when the pump 6 is in operation, the brake fluid is not drawn from the secondary chamber 41S but is drawn only from the primary chamber 41P to be discharged, because the pump 6 is included in the P system (the hydraulic passage therein). In this manner, the apparatus 1 basically uses the brake fluid in the primary chamber 41P but does not use the brake fluid in the secondary chamber 41S. Therefore, it is possible to prevent the brake fluid in the primary chamber 41P and the brake fluid in the secondary chamber 41S from being mixed with each other on the apparatus 1 side (via the connection hydraulic passage 16). Therefore, it is possible to easily prevent losses of the balances between the inputs and the outputs of the brake fluid in the respective chambers 41P and 41S in the master cylinder 4, comparing before and after a startup of the apparatus 1. Since the above-described effect can be acquired by using the brake fluid in one of the hydraulic chambers 41 in the master cylinder 4, the apparatus 1 may be configured to use the brake fluid in the secondary chamber 41S but not to use the brake fluid in the primary chamber 41P. For example, the pump 6 may be configured not to draw the brake fluid from the primary chamber 41P but to draw the brake fluid only from the secondary chamber 41S.

When the pump 6 is in operation, the apparatus 1 actuates the shutoff valve 20S in the S system in the valve closing direction. As a result, the brake fluid is prevented from flowing into the secondary chamber 41S in the master cylinder 4. For example, when the boosting assist control is performed during the normal brake operation and the pressures in the wheel cylinders 5 are increased by the pump 6, the apparatus 1 actuates the shutoff valve 20S in the S system in the valve closing direction. As a result, the brake fluid is prevented from flowing from the supply hydraulic passage 11S having a high pressure to the secondary chamber 41S. In this manner, the apparatus 1 does not return the brake fluid used for the control, which is supplied from the primary chamber 41P, to the secondary chamber 41S. Therefore, it is possible to easily prevent losses of the balances between the inputs and the outputs of the brake fluid in the respective chambers 41P and 41S in the master cylinder 4, comparing before and after a startup of the apparatus 1. In other words, the apparatus 1 basically performs the control by using the brake fluid in only one (the primary chamber 41P) of the chambers in the master cylinder 4, and returns the brake fluid that becomes unnecessary only to this one chamber (the primary chamber 41P), thereby improving the balances of the inputs and the outputs in the fluid amounts in the respective chambers 41P and 41S.

For example, during the ABS control, the apparatus 1 actuates the shutoff valve 20S in the S system in the valve closing direction. As a result, the brake fluid is prevented from flowing into the secondary chamber 41S when the pump 6 draws the brake fluid introduced into the internal reservoir 8 by the pressure reduction control, and returns the brake fluid to the master cylinder 4 side. In other words, the brake fluid is returned only to the primary chamber 41P. Therefore, it is possible to easily prevent losses of the balances between the inputs and the outputs of the brake fluid in the respective chambers 41P and 41S in the master cylinder 4, comparing before and after a start of the ABS control. More specifically, during the normal brake control before the ABS control is started (regardless of execution of the boosting assist control), the apparatus 1 actuates the shutoff valve 20S in the S system in the valve closing direction except when the brake pedal 2 starts to be pressed. As a result, the apparatus 1 basically increases the pressures in the respective wheel cylinders 5 by using only the brake fluid in the primary chamber 41P. On the other hand, the secondary piston 42S in the master cylinder 4 rarely performs a stroke unlike the primary piston 42P due to the actuation of the shutoff valve 20S in the valve closing direction. When the ABS control is started in this state, if the brake fluid from the supply hydraulic passage 11S is delivered into the secondary chamber 41S, this may lead to a return of the brake fluid in the secondary chamber 41S to the reservoir tank 40 via the refill port 402S. On the other hand, during the ABS control, the apparatus 1 according to the present embodiment maintains the shutoff valve 20S in the S system actuated in the valve closing direction, thereby preventing the brake fluid from being delivered from the supply hydraulic passage 11S into the secondary chamber 41S. The brake fluid discharged from the pump 6 to the supply hydraulic passage 11P and delivered to the supply hydraulic passage 11S via the connection hydraulic passage 16 is blocked by the shutoff valve 20S actuated in the valve closing direction, and therefore is not supplied to the secondary chamber 41S. Therefore, the present embodiment can avoid the above-described situation, and can establish the balance between the input and output of the brake fluid in the apparatus 1. In other words, the brake fluid in the respective wheel cylinders 5 are originally supplied from the primary chamber 41P. When the brake fluid is returned from these wheel cylinders 5 to the master cylinder 4, the apparatus 1 actuates the shutoff valve 20S in the valve closing direction, and returns the brake fluid to the primary chamber 41P that is the supply source. As a result, it is possible to prevent a loss of the balance between the input and output of the brake fluid. The same also applies to the operation during the boosting assist control.

### <Effects>

In the following description, effects provided by the brake apparatus 1 according to the first embodiment will be described. (A1) The brake apparatus includes the closed circuit having the pump 6 configured to increase the hydraulic pressures in the wheel cylinders 5a to 5d mounted on the respective wheels FL to RR with use of the brake fluid drawn from the master cylinder 4. The brake apparatus includes the supply hydraulic passage 11P (a primary system hydraulic passage) connecting at least one wheel cylinders 5a and 5d of the wheel cylinders 5a to 5d and the primary chamber 41P (the first chamber) in the master cylinder 4 to each other, and the supply hydraulic passage 11S (a secondary system hydraulic passage) connecting the remaining wheel cylinders 5b and 5c of the wheel cylinders 5a to 5d and the secondary chamber 41S (the second chamber) in the master cylinder 4 to each other. The pump 6 is connected so as to be able to supply the brake fluid to the supply hydraulic passage 11P and the supply hydraulic passage 11S. Therefore, the pump 6 does not have to be prepared for each system, which can avoid the increase in the number of parts.

(A2) The pump 6 is included in the P system (one of the supply hydraulic passage 11P and the supply hydraulic passage 11S). Therefore, the configuration can be simplified.

(A3) The brake apparatus 1 includes the connection hydraulic passage 16 connecting the supply hydraulic passage 11P (the primary system hydraulic passage) and the supply hydraulic passage 11S (the secondary system hydraulic passage) to each other. Therefore, the pump 6 can easily supply the brake fluid (pressure) to the respective systems.

(A4) The pump 6 is included in the P system (the system including the supply hydraulic passage 11P), and draws the brake fluid only from the primary chamber 41P (the first chamber) in the master cylinder 4. Therefore, it is possible to prevent losses of the balances between the inputs and the outputs of the brake fluid in the respective chambers 41P and 41S.

(A5) The shutoff valve 20S (the cutoff valve) is disposed between the connection point of the supply hydraulic passage 11S (the secondary system hydraulic passage) to the connection hydraulic passage 16 and the secondary chamber 41S (the second chamber) in the master cylinder 4, and is actuated in the valve closing direction when the hydraulic pressures in the wheel cylinders 5 are increased by the pump 6. Therefore, it is possible to prevent losses of the balances between the inputs and the outputs of the brake fluid in the respective chambers 41P and 41S.

(A6) The brake apparatus 1 includes the communication valve 26 (a switching valve) in the connection hydraulic passage 16. Therefore, the both systems can be separated from each other, which can improve the reliability.

(A8) The brake apparatus 1 includes the first intake hydraulic passage 13 in the P system (one of the systems) that is connected from the primary chamber 41P (one of the chambers) in the master cylinder 4 to the intake side of the pump 6, and the internal reservoir 8 (a reservoir) disposed in the first intake hydraulic passage 13 and configured in such a manner that the brake fluid discharged from the wheel cylinders 5a to 5d by the anti-lock brake control is introduced therein. Therefore, the internal reservoir 8 does not have to be prepared for each system, whereby the size of the apparatus 1 can be reduced.

(A9) The pump 6 draws the brake fluid introduced into the internal reservoir 8 by the anti-lock brake control, and transmits the brake fluid only to the primary chamber 41P (the one of the chambers) in the master cylinder 4. Therefore, it is possible to prevent losses of the balances between the inputs and the outputs of the brake fluid in the respective chambers 41P and 41S.

(A11) The pump 6 is the gear pump. Therefore, the anti-noise performance can be maintained.

(B1) The brake apparatus 1 includes the closed circuit. The closed circuit includes the supply hydraulic passage 11P (the primary system hydraulic passage) connecting at least one wheel cylinders 5a and 5d of the plurality of wheel cylinders 5a to 5d mounted on the wheels FL to RR and the primary chamber 41P (the first chamber) in the master cylinder 4 to each other, the supply hydraulic passage 11S (the secondary system hydraulic passage) connecting the remaining wheel cylinders 5b and 5c of the plurality of wheel cylinders 5a to 5d and the secondary chamber 41S (the second chamber) in the master cylinder 4 to each other, the connection hydraulic passage 16 connecting the supply hydraulic passage 11P and the supply hydraulic passage 11S to each other, and the pump 6 (the hydraulic source) connected so as to be able to supply the brake fluid to the supply hydraulic passage 11P and the supply hydraulic passage 11S and configured to increase the hydraulic pressures in the plurality of wheel cylinders 5a to 5d with use of the brake fluid in the primary chamber 41P (one of the first chamber and the second chamber). Therefore, the hydraulic source does not have to be prepared for each system, which can avoid the increase in the number of parts.

(C1) The brake apparatus 1 includes the supply hydraulic passage 11P (the primary system hydraulic passage) connecting at least one wheel cylinders 5a and 5d of the plurality of wheel cylinders 5a to 5d mounted on the wheels FL to RR and the primary chamber 41P (the first chamber) in the master cylinder 4 to each other, the supply hydraulic passage 11S (the secondary system hydraulic passage) connecting the remaining wheel cylinders 5b and 5c of the plurality of wheel cylinders 5a to 5d and the secondary chamber 41S (the second chamber) in the master cylinder 4 to each other, the connection hydraulic passage 16 connecting the supply hydraulic passage 11P and the supply hydraulic passage 11S to each other, the pump 6 connected so as to be able to supply the brake fluid to the supply hydraulic passage 11P and the supply hydraulic passage 11S with use of the brake fluid in the primary chamber 41P or the secondary chamber 41S in the master cylinder 4, and the return hydraulic passage (the hydraulic passages 11P and 11S) for returning the brake supplied from the pump 6 to the respective hydraulic passages 11P and 11S to the primary chamber 41P or the secondary chamber 41S. Therefore, a similar effect to the effect described in the item (A1)) can be acquired.

(C2) The pump 6 is the rotational gear pump. Therefore, a similar effect to the effect described in the item (A11) can be acquired.

(C3) The pump 6 is included in the supply hydraulic passage 11P (the primary system hydraulic passage), and draws the brake fluid only from the primary chamber 41P (the first chamber) in the master cylinder 4. Therefore, a similar effect to the effect described in the item (A4) can be acquired.

(C4) The pump 6 draws the brake fluid only from the primary chamber 41P (the one of the chambers) in the master cylinder 4, and the shutoff valve 20S (the cutoff valve) is disposed between the connection point of the supply hydraulic passage 11S in the S system, which is connected to the secondary chamber 41S (the other of the chambers) in the master cylinder 4, to the connection hydraulic passage 16 and the secondary chamber 41S in the master cylinder 4, and is actuated in the valve closing direction when the hydraulic pressures in the wheel cylinders 5 are increased by the pump 6. Therefore, similar effects to the effects described in the items (A4) and (A5) can be acquired.

### Second Embodiment

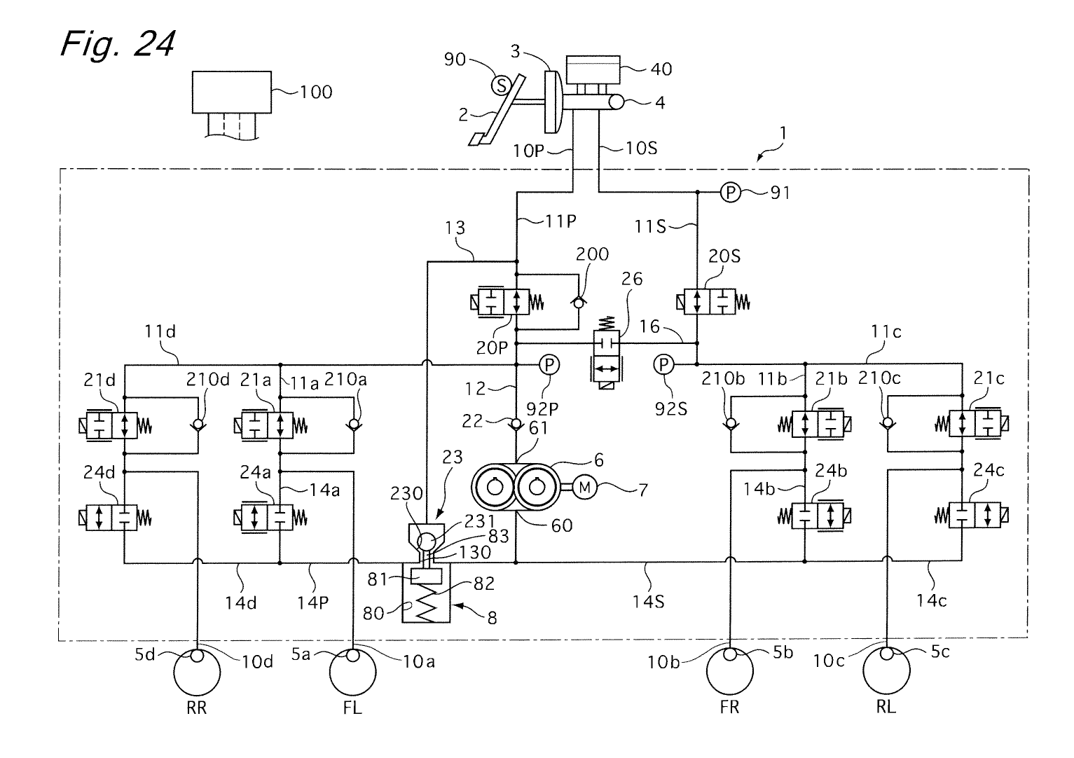

FIG. 24 illustrates a hydraulic passage configuration of a brake apparatus 1 according to a second embodiment. The apparatus 1 according to the present embodiment does not include the second intake hydraulic passage 15 and the intake valve 25. Except for that, the apparatus 1 according to the present embodiment is configured similarly to the first embodiment. The omission of the second intake hydraulic passage 15 and the intake valve 25 allows the apparatus 1 to be more simply configured, thereby further reducing the cost and the size of the apparatus 1. Because the apparatus 1 according to the present embodiment does not have the function of preventing the deterioration of the pedal feeling with use of the intake valve 25, the apparatus 1 according to the present embodiment is advantageous when the brake control is not supposed to include the boosting assist control and the regenerative coordination brake control. Other effects are similar to the first embodiment.

### Third Embodiment

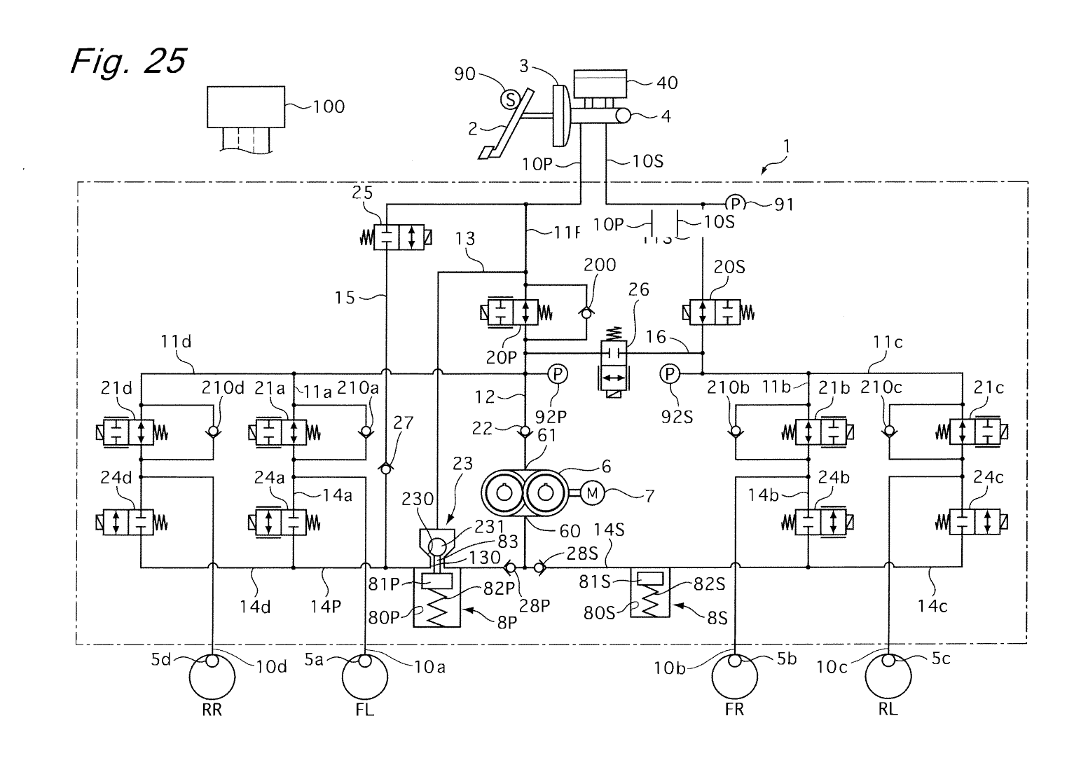

FIG. 25 illustrates a hydraulic passage configuration of a brake apparatus 1 according to a third embodiment. The apparatus 1 according to the present embodiment includes a second internal reservoir 8S in the pressure reduction hydraulic passage 14S in the S system. The internal reservoir 8S does not include a check valve as a pressure adjustment valve, and is not provided with the pressure adjustment function. A check valve 28S, which permits the brake fluid to only flow from the internal reservoir 8S toward the pump 6, is disposed in the pressure reduction hydraulic passage 14S between the internal reservoir 8S and the pump 6. A check valve 28P, which permits the brake fluid to only flow from the internal reservoir 8P toward the pump 6, is disposed in the second intake hydraulic passage 15 between the internal reservoir 8P in the P system and the pump 6. Except for that, the apparatus 1 according to the present embodiment is configured similarly to the first embodiment. Providing the internal reservoirs 8 in the both systems allows, for example, the respective internal reservoirs 8 to have reduced depths (axial dimensions), thereby realizing a reduction in the size of the entire apparatus 1. Further, providing the internal reservoirs 8 in the both systems can prevent the brake fluid delivered to the pressure reduction hydraulic passage 14 when the pressure reduction valves 24 in one of the systems are opened from being introduced into the other system. Further, providing the check valve 28 can further reliably prevent the brake fluid in one of the systems from being introduced into the other system. Other effects are similar to the first embodiment.

### Fourth Embodiment

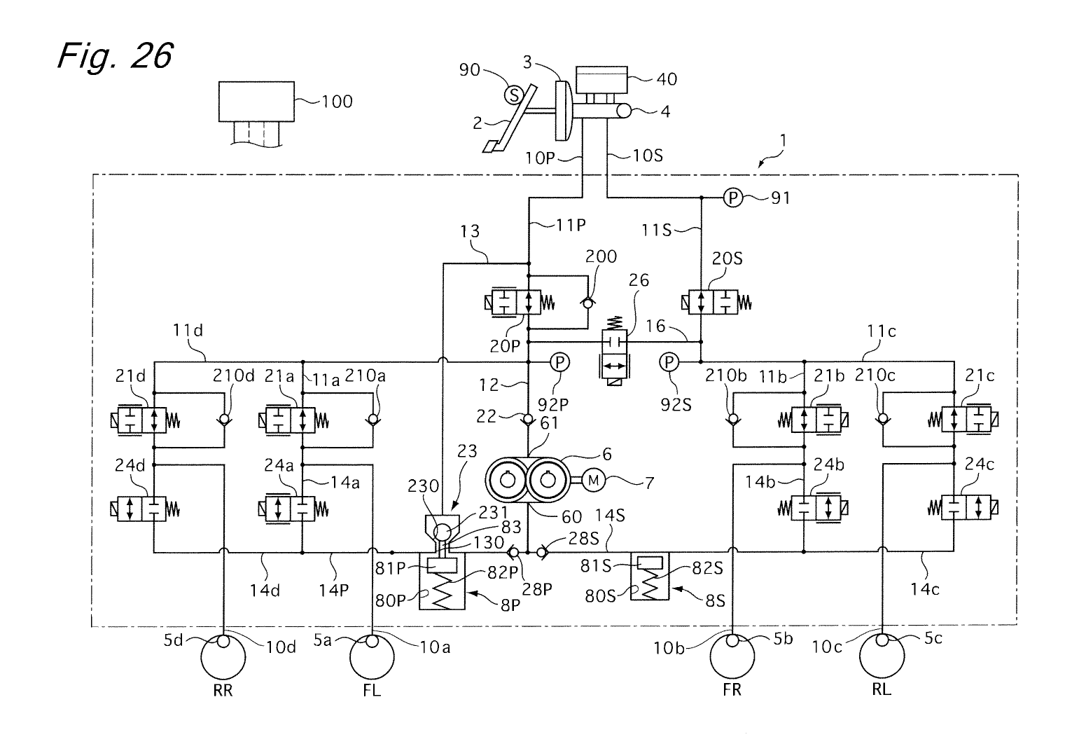

FIG. 26 illustrates a hydraulic passage configuration of a brake apparatus 1 according to a fourth embodiment. The apparatus 1 according to the present embodiment does not include the second intake hydraulic passage 15 and the intake valve 25 in a similar manner to the second embodiment. Further, the apparatus 1 according to the present embodiment includes the second internal reservoir 8S in the pressure reduction hydraulic passage 14S in the S system, and the check valves 28P and 28S in a similar manner to the third embodiment. Except for that, the apparatus 1 according to the present embodiment is configured similarly to the first embodiment. Therefore, the present embodiment can acquire similar effects to the third and fourth embodiments.

### Other Embodiments

Having described exemplary embodiments for carrying out the present invention based on the first to forth embodiments, the specific configuration of the present invention is not limited to the first to forth embodiments. The present invention includes the embodiment even with a design modification made thereto without departing from the scope and the spirit of the present invention. The configuration of the hydraulic brake system is not limited to the embodiments. For example, the booster 3 does not have to be the negative pressure type booster, and may be a hydraulic booster, a link type booster, or the like. Further, the booster 3 may be omitted. The configuration of the closed circuit that can increase the hydraulic pressures in the respective wheel cylinders 5 with use of the brake fluid in the hydraulic chamber 41 in the master cylinder 4 and returns the brake fluid used in the above-described pressure increases to the hydraulic chamber 41 is not limited to the embodiments, as long as this circuit includes two hydraulic passages that connect the two chambers 41P and 41S in the master cylinder 4 and the wheel cylinders 5 to each other. For example, the supply hydraulic passage 11P (the brake pipe 10P) in the P system only has to connect at least one wheel cylinder 5 and the primary chamber 41P in the master cylinder 4. The supply hydraulic passage 11P may be configured to connect the primary chamber 41P to only one wheel cylinder 5, instead of connecting the primary chamber 41P to the two wheel cylinders 5a and 5b, like the embodiments. In this case, the supply hydraulic passage 11S in the S system is connected to the remaining wheel cylinders 5. Similarly, the supply hydraulic passage 11S in the S system only has to connect at least one wheel cylinder 5 to the secondary chamber 41S. The internal reservoir 8 does not have to have the pressure adjustment function including the check valve 23. In this case, an electromagnetic valve that switches communication and discommunication of the first intake hydraulic passage 13 may be disposed between the connection point of the first intake hydraulic passage 13 to the supply hydraulic passage 11P and the internal reservoir 8, and the internal reservoir 8 may be located in the pressure reduction hydraulic passage 14P, instead of the first intake hydraulic passage 13. The hydraulic source capable of increasing the hydraulic pressures in the wheel cylinders 5 with use of the brake fluid in the master cylinder 4 may be embodied by not only the pump 6 but also an accumulator or the like.

Further, the present invention may be embodied as the following embodiments.

### Embodiment (1)

A brake apparatus includes a closed circuit including a pump configured to increase hydraulic pressures in wheel cylinders mounted on wheels with use of brake fluid drawn from a master cylinder. The brake apparatus includes a primary system hydraulic passage connecting at least one wheel cylinder of the wheel cylinders and a first chamber in the master cylinder to each other, and a secondary system hydraulic passage connecting remaining wheel cylinder of the wheel cylinders and a second chamber in the master cylinder to each other. The pump is connected so as to be able to supply the brake fluid to the primary system hydraulic passage and the secondary system hydraulic passage.

### Embodiment (2)

In the brake apparatus according to the embodiment (1), the pump is included in one of systems of the primary system hydraulic passage and the secondary system hydraulic passage.

### Embodiment (3)

The brake apparatus according to the embodiment (2) further includes a connection hydraulic passage connecting the primary system hydraulic passage and the secondary system hydraulic passage to each other.

### Embodiment (4)

In the brake apparatus according to the embodiment (3), the pump is included in the system of the primary system hydraulic passage, and is configured to draw the brake fluid only from the first chamber in the master cylinder.

### Embodiment (5)

In the brake apparatus according to the embodiment (4), a cutoff valve is disposed between a connection point of the secondary system hydraulic passage to the connection hydraulic passage and the second chamber in the master cylinder. The cutoff valve is configured to be actuated in a valve closing direction when the hydraulic pressures in the wheel cylinders are increased by the pump.

### Embodiment (6)

The brake apparatus according to the embodiment (4) further includes a switching valve in the connection hydraulic passage.

### Embodiment (7)

In the brake apparatus according to the embodiment (6), the switching valve is a normally-closed valve.

### Embodiment (8)

The brake apparatus according to the embodiment (3) further includes a first intake hydraulic passage provided in the one of the systems and connected from one of the chambers in the master cylinder to an intake side of the pump, and a reservoir disposed in the first intake hydraulic passage and configured in such a manner that the brake fluid discharged from the wheel cylinders by anti-lock brake control are introduced into the reservoir.

### Embodiment (9)

In the brake apparatus according to the embodiment (8), the pump is configured to dram, the brake fluid introduced into the reservoir by the anti-lock brake control and transmit the brake fluid only to the one of the chambers in the master cylinder.

### Embodiment (10)

The brake apparatus according to the embodiment (2) further includes a first intake hydraulic passage provided in the one of the systems and connected from one of the chambers in the master cylinder to an intake side of the pump, a reservoir disposed in the first intake hydraulic passage and configured in such a manner that the brake fluid discharged from the wheel cylinders by anti-lock brake control are introduced into the reservoir, and a second intake hydraulic passage provided in parallel with the first intake hydraulic passage and connecting the one of the chambers in the master cylinder and the reservoir to each other. An intake valve is disposed in the second intake hydraulic passage.

### Embodiment (11)

In the brake apparatus according to the embodiment (1), the pump is a gear pump.

### Embodiment (12)

A brake apparatus includes a closed circuit. The closed circuit includes a primary system hydraulic passage connecting at least one wheel cylinder of a plurality of wheel cylinders mounted on wheels and a first chamber in a master cylinder to each other, a secondary system hydraulic passage connecting remaining wheel cylinder of the plurality of wheel cylinders and a second chamber in the master cylinder to each other, a connection hydraulic passage connecting the primary system hydraulic passage and the secondary system hydraulic passage to each other, and a hydraulic source connected so as to be able to supply the brake fluid to the primary system hydraulic passage and the secondary system hydraulic passage, and configured to increase the hydraulic pressures in the plurality of wheel cylinders with use of the brake fluid in one of the first chamber and the second chamber.

### Embodiment (13)

In the brake apparatus according to the embodiment (12), the hydraulic source is included in a hydraulic passage in a same system as the primary system hydraulic passage. The brake fluid is supplied only from the first chamber in the master cylinder.

### Embodiment (14)

In the brake apparatus according to the embodiment (13), a cutoff valve is disposed between a connection point of the secondary system hydraulic passage to the connection hydraulic passage and the second chamber in the master cylinder. The cutoff valve is configured to be actuated in a valve closing direction when the hydraulic pressures in the wheel cylinders are increased by the hydraulic source.

### Embodiment (15)

A brake apparatus includes a primary system hydraulic passage connecting at least one wheel cylinder of a plurality of wheel cylinders mounted on wheels and a first chamber in a master cylinder to each other, a secondary system hydraulic passage connecting remaining wheel cylinder of the plurality of wheel cylinders and a second chamber in the master cylinder to each other, a connection hydraulic passage connecting the primary system hydraulic passage and the secondary system hydraulic passage to each other, a pump connected so as to be able to supply the brake fluid to the primary system hydraulic passage and the secondary system hydraulic passage with use of the brake fluid in the first chamber or the second chamber in the master cylinder, and a return hydraulic passage configured to return the brake fluid supplied from the pump to the respective hydraulic passages to the first chamber or the second chamber.

### Embodiment (16)

In the brake apparatus according to the embodiment (15), the pump is a rotational gear pump.

### Embodiment (17)

In the brake apparatus according to the embodiment (15), the pump is included in the primary system hydraulic passage, and is configured to draw the brake fluid only from the first chamber in the master cylinder.

### Embodiment (18)

In the brake apparatus according to the embodiment (15), the pump is configured to draw the brake fluid only from one of the chambers in the master cylinder. A cutoff valve is disposed between a connection point of the hydraulic passage in a system connected to the other of the chambers in the master cylinder to the connection hydraulic passage, and the other of the chambers in the master cylinder. The cutoff valve is configured to be actuated in a valve closing direction when the hydraulic pressures in the wheel cylinders are increased by the pump.

### Embodiment (19)

The brake apparatus according to the embodiment (15) further includes a first intake hydraulic passage provided in the primary system hydraulic passage, and connected from the first chamber in the master cylinder to an intake side of the pump, and a reservoir disposed in the first intake hydraulic passage, and configured in such a manner that the brake fluid discharged from the wheel cylinders by anti-lock brake control are introduced into the reservoir.

### Embodiment (20)

In the brake apparatus according to the embodiment (19), the pump is configured to draw the brake fluid introduced into the reservoir by the anti-lock brake control and transmit the brake fluid only to the first chamber in the master cylinder.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Applications No. 2014-019152 filed on Feb. 4, 2014. The entire disclosure of Japanese Patent Application No. 2014-019152 filed on Feb. 4, 2014 including specification, claims, drawings and summary are incorporated herein by reference in its entirety.

What is claimed is:

1. A brake apparatus comprising a closed circuit including a pump configured to increase hydraulic pressures in wheel cylinders mounted on wheels with use of brake fluid drawn from a master cylinder, the brake apparatus comprising;
a primary system hydraulic passage connecting at least one wheel cylinder of the wheel cylinders and a first chamber in the master cylinder to each other; and
a secondary system hydraulic passage connecting remaining wheel cylinder of the wheel cylinders and a second chamber in the master cylinder to each other,
wherein the pump is connected so as to be able to supply the brake fluid to the primary system hydraulic passage and the secondary system hydraulic passage.

2. The brake apparatus according to claim 1, wherein the pump is included in one of systems of the primary system hydraulic passage and the secondary system hydraulic passage.

3. The brake apparatus according to claim 2, further comprising a connection hydraulic passage connecting the primary system hydraulic passage and the secondary system hydraulic passage to each other.

4. The brake apparatus according to claim 3, wherein the pump is included in the system of the primary system hydraulic passage, and is configured to draw the brake fluid only from the first chamber in the master cylinder.

5. The brake apparatus according to claim 4, wherein a cutoff valve is disposed between a connection point of the secondary system hydraulic passage to the connection hydraulic passage and the second chamber in the master cylinder, and
wherein the cutoff valve is configured to be actuated in a valve closing direction when the hydraulic pressures in the wheel cylinders are increased by the pump.

6. The brake apparatus according to claim 4, further comprising a switching valve in the connection hydraulic passage.

7. The brake apparatus according to claim 6, wherein the switching valve is a normally-closed valve.

8. The brake apparatus according to claim 3, further comprising:
a first intake hydraulic passage provided in the one of the systems and connected from one of the chambers in the master cylinder to an intake side of the pump; and
a reservoir disposed in the first intake hydraulic passage and configured in such a manner that the brake fluid discharged from the wheel cylinders by anti-lock brake control are introduced into the reservoir.

9. The brake apparatus according to claim 8, wherein the pump is configured to draw the brake fluid introduced into the reservoir by the anti-lock brake control and transmit the brake fluid only to the one of the chambers in the master cylinder.

10. The brake apparatus according to claim 2, further comprising:
a first intake hydraulic passage provided in the one of the systems and connected from one of the chambers in the master cylinder to an intake side of the pump;
a reservoir disposed in the first intake hydraulic passage and configured in such a manner that the brake fluid discharged from the wheel cylinders by anti-lock brake control are introduced into the reservoir; and
a second intake hydraulic passage provided in parallel with the first intake hydraulic passage and connecting the one of the chambers in the master cylinder and the reservoir to each other,
wherein an intake valve is disposed in the second intake hydraulic passage.

11. The brake apparatus according to claim 1, wherein the pump is a gear pump.

12. A brake apparatus comprising:
a closed circuit including:
a primary system hydraulic passage connecting at least one wheel cylinder of a plurality of wheel cylinders mounted on wheels and a first chamber in a master cylinder to each other;
a secondary system hydraulic passage connecting remaining wheel cylinder of the plurality of wheel cylinders and a second chamber in the master cylinder to each other;
a connection hydraulic passage connecting the primary system hydraulic passage and the secondary system hydraulic passage to each other; and
a hydraulic source connected so as to be able to supply the brake fluid to the primary system hydraulic passage and the secondary system hydraulic passage, and configured to increase the hydraulic pressures in the plurality of wheel cylinders with use of the brake fluid in one of the first chamber and the second chamber.

13. The brake apparatus according to claim 12, wherein the hydraulic source is included in a hydraulic passage in a same system as the primary system hydraulic passage, and
wherein the brake fluid is supplied only from the first chamber in the master cylinder.

14. The brake apparatus according to claim 13, wherein a cutoff valve is disposed between a connection point of the secondary system hydraulic passage to the connection hydraulic passage and the second chamber in the master cylinder, and
wherein the cutoff valve is configured to be actuated in a valve closing direction when the hydraulic pressures in the wheel cylinders are increased by the hydraulic source.

15. A brake apparatus comprising:
a primary system hydraulic passage connecting at least one wheel cylinder of a plurality of wheel cylinders mounted on wheels and a first chamber in a master cylinder to each other; and
a secondary system hydraulic passage connecting remaining wheel cylinder of the plurality of wheel cylinders and a second chamber in the master cylinder to each other;
a connection hydraulic passage connecting the primary system hydraulic passage and the secondary system hydraulic passage to each other;
a pump connected so as to be able to supply the brake fluid to the primary system hydraulic passage and the secondary system hydraulic passage with use of the brake fluid in the first chamber or the second chamber in the master cylinder; and
a return hydraulic passage configured to return the brake fluid supplied from the pump to the respective hydraulic passages to the first chamber or the second chamber.

16. The brake apparatus according to claim 15, wherein the pump is a rotational gear pump.

17. The brake apparatus according to claim 15, wherein the pump is included in the primary system hydraulic passage, and is configured to draw the brake fluid only from the first chamber in the master cylinder.

18. The brake apparatus according to claim 15, wherein the pump is configured to draw the brake fluid only from one of the chambers in the master cylinder,
wherein a cutoff valve is disposed between a connection point of the hydraulic passage in a system connected to the other of the chambers in the master cylinder to the connection hydraulic passage, and the other of the chambers in the master cylinder, and
wherein the cutoff valve is configured to be actuated in a valve closing direction when the hydraulic pressures in the wheel cylinders are increased by the pump.

19. The brake apparatus according to claim 15, further comprising:
a first intake hydraulic passage provided in the primary system hydraulic passage, and connected from the first chamber in the master cylinder to an intake side of the pump; and
a reservoir disposed in the first intake hydraulic passage, and configured in such a manner that the brake fluid discharged from the wheel cylinders by anti-lock brake control are introduced into the reservoir.

20. The brake apparatus according to claim 19, wherein the pump is configured to draw the brake fluid introduced into the reservoir by the anti-lock brake control and transmit the brake fluid only to the first chamber in the master cylinder.
